(19) United States
(12) Patent Application Publication
(10) Pub. No.: US 2023/0288724 A1
(43) Pub. Date: Sep. 14, 2023

(54) AERIAL FLOATING IMAGE INFORMATION DISPLAY SYSTEM AND LIGHT SOURCE APPARATUS USED IN THE SAME

(71) Applicant: Maxell, Ltd., Otokuni-gun, Kyoto (JP)

(72) Inventors: Koji HIRATA, Kyoto (JP); Koji FUJITA, Kyoto (JP); Toshinori SUGIYAMA, Kyoto (JP)

(73) Assignee: Maxell, Ltd., Otokuni-gun, Kyoto (JP)

(21) Appl. No.: 18/019,491

(22) PCT Filed: Aug. 4, 2021
(86) PCT No.: PCT/JP2021/028932

§ 371 Date: Feb. 3, 2023

(30) Foreign Application Priority Data
Aug. 6, 2020 (JP) 2020-133499
Jul. 28, 2021 (JP) 2021-123260

(51) Int. Cl. F21V 8/00; G02B 30/56

(52) U.S. Cl. CPC G02B 6/0018; G02B 30/56; G02B 6/0031; G02B 6/0025

(57) ABSTRACT

An aerial floating image display apparatus includes: a display panel displaying an image; a light source apparatus; and a retroreflector capable of reflecting image light having been emitted from the display panel and causing the reflected light to display an aerial floating image that is an actual image in air, the light source apparatus includes: a light source of a point type or a surface type; a reflector reflecting light having been emitted from the light source; and a light guiding body guiding light having been emitted from the reflector toward the display panel, and a reflection surface of the reflector has a shape that is asymmetric across an optical axis of the light having been emitted from the light source. By such a configuration, the image can be preferably displayed outside a space. The present invention contributes to the sustainable development goal that are “the third goal: Good Health and Well-being (for all people)”, “the ninth goal: Industry, Innovation and Infrastructure” and “the eleventh goal: Sustainable Cities and Communities”.

### TECHNICAL FIELD

The present invention relates to an aerial floating image information display system and a light source apparatus used in the same.

### BACKGROUND ART

As an aerial floating image information display system, an image display apparatus that directly displays images to outside and a display method that displays images as an aerial screen have been already known. And, a detection system that reduces erroneous detection in an operation on an operation surface of a displayed aerial image has been also disclosed in, for example, a Patent Document 1.

### RELATED ART DOCUMENT

### Patent Document

Patent Document 1: Japanese Patent Application Laid-Open Publication No. 2019-128722

### SUMMARY OF THE INVENTION

### Problems to be Solved by the Invention

However, regarding the aerial floating image information display system and the method that reduces the erroneous detection in the operation of the aerial image, a technique of optimizing design including a light source of an image display apparatus to be an image source of the aerial floating image has not been considered.

An objective of the present invention is to provide a technique capable of displaying favorable images having high visual recognition (apparent resolution and contrast) and having reduced erroneous detection in an operation in a displayed aerial image.

### Means for Solving the Problems

In order to solve the issue, for example, configurations described in claims are adopted. The present application invention includes a plurality of means for solving the issue, and an aerial floating image display apparatus to be its example will be exemplified below. The aerial floating image display apparatus exemplified to be the example of the present invention includes: a display panel displaying an image; a light source apparatus; and a retroreflector capable of reflecting image light having been emitted from the display panel and causing the reflected light to display an aerial floating image that is an actual image in air. In this case, the light source apparatus includes: a light source of a point type or a surface type; a reflector reflecting light having been emitted from the light source; and a light guiding body guiding light having been emitted from the reflector, toward the display panel, and a reflection surface of the reflector has a shape that is asymmetric across an optical axis of the light having been emitted from the light source.

### Effects of the Invention

According to the present invention, an aerial floating information display system or an aerial floating image display apparatus capable of favorably displaying aerial floating image information and having a sensing function with less erroneous detection can be achieved. Other issues, configurations and effects than those as described above will be apparent from the following explanation for embodiments.

### BRIEF DESCRIPTIONS OF THE DRAWINGS

FIG. 1 is a diagram showing an example of a use mode of an aerial floating image information display system according to an embodiment of the present invention;

FIG. 2 is a diagram showing examples of a principal-portion configuration and a retroreflection-portion configuration of the aerial floating image information display system according to the embodiment of the present invention;

FIG. 3 is a diagram showing another example of the principal-portion configuration of the aerial floating image information display system according to the embodiment of the present invention;

FIG. 4 is a diagram showing still another example of the principal-portion configuration of the aerial floating image information display system according to the embodiment of the present invention;

FIG. 5 is an explanatory diagram for explaining a function of a sensing apparatus used in an aerial floating image information display system;

FIG. 6 is an explanatory diagram for explaining a principle of three-dimensional image display used in an aerial floating image information display system;

FIG. 7 is an explanatory diagram for explaining a measuring system that evaluates a property of a reflection-type light polarizer;

FIG. 8 is a characteristic diagram showing a transmittance property with respect to a light-ray incident angle of a transmission axis of a reflection-type light polarizer;

FIG. 9 is a characteristic diagram showing a transmittance property with respect to a light-ray incident angle of a reflection axis of a reflection-type light polarizer;

FIG. 10 is a characteristic diagram showing a transmittance property with respect to a light-ray incident angle of a transmission axis of a reflection-type light polarizer;

FIG. 11 is a characteristic diagram showing a transmittance property with respect to a light-ray incident angle of a reflection axis of a reflection-type light polarizer;

FIG. 12 is a cross-sectional diagram showing an example of a specific configuration of a light source apparatus;

FIG. 13 is a cross-sectional diagram showing an example of a specific configuration of a light source apparatus;

FIG. 14 is a cross-sectional diagram showing an example of a specific configuration of a light source apparatus;

FIG. 15 is a layout showing the principal portion of the aerial floating image information display system according to the embodiment of the present invention;

FIG. 16 is a cross-sectional diagram showing a configuration of an image display apparatus of the aerial floating image information display system according to the embodiment of the present invention;

FIG. 17 is a cross-sectional diagram showing an example of a specific configuration of a light source apparatus;

FIG. 18 is a cross-sectional diagram showing an example of a specific configuration of a light source apparatus;

FIG. 19 is a cross-sectional diagram showing an example of a specific configuration of a light source apparatus;

FIG. 20 is an explanatory diagram for explaining a diffuse property of a light source of an image display apparatus;

FIG. 21 is an explanatory diagram for explaining a diffuse property of an image display apparatus;

FIG. 22 is an explanatory diagram for explaining a diffuse property of an image display apparatus;

FIG. 23 is a cross-sectional diagram showing a configuration of an image display apparatus configuring an aerial floating image information display system;

FIG. 24 is an explanatory diagram for explaining a principle of occurrence of a ghost image occurring in an aerial floating image information display system according to a related art;

FIG. 25 is a cross-sectional diagram showing a configuration of an image display apparatus of the aerial floating image information display system according to the embodiment of the present invention;

FIG. 26 is a diagram showing another example of a specific configuration of a light source apparatus;

FIG. 27A is a diagram showing another example of the specific configuration of the light source apparatus;

FIG. 27B is a cross-sectional diagram showing another example of the specific configuration of the light source apparatus;

FIG. 27C is a cross-sectional diagram showing another example of the specific configuration of the light source apparatus;

FIG. 27D is a diagram in extraction of a part of another example of the specific configuration of the light source apparatus;

FIG. 28A is a diagram showing another example of the specific configuration of the light source apparatus;

FIG. 28B is a cross-sectional diagram showing another example of the specific configuration of the light source apparatus;

FIG. 29 is a diagram showing another example of the specific configuration of the light source apparatus; and

FIG. 30 is a cross-sectional diagram of an example of a shape of a diffuse plate of another example of the specific configuration of the light source apparatus.

### BEST MODE FOR CARRYING OUT THE INVENTION

Hereinafter, embodiments of the present invention will be explained in detail with reference to the drawings. Note that the present invention is not limited to contents of embodiments (also referred to as “present disclosure”) explained below. The present invention also covers the invention's spirit, the scope of the technical idea described in claims, or equivalents. The configuration of the embodiment (example) explained below is only one example, and can be variously modified and altered within the scope of the technical idea disclosed in the present specification by the person skilled in the art.

The components having the same or similar function are denoted with the same reference sign through the drawings for explaining the present invention, and the different name is appropriately used. On the other hand, the repetitive explanation for the function and others may be omitted. In the following explanation for the embodiments, note that the floating image in air is expressed as a term “aerial floating image”. In place of this term, this may be expressed as “spatial image”, “aerial image”, “spatial floating image”, “aerial floating optical image of display image”, “spatial floating optical image of display image” or others. The term “aerial floating image” mainly used in the explanation for the embodiments is used as a typical example of these terms.

The present disclosure relates to an information display system capable of, for example, transmitting an image based on image light emitted from an image light emission source having a large area, through a transparent member separating a space such as a glass of a show window or others, and displaying the image as the aerial floating image inside or outside a shop (space). Also, the present disclosure relates to a large digital signage system made of a plurality of the information display systems.

According to the following embodiments, for example, high-resolution image information can be displayed above a glass surface of a show window or a light-transmittable plate member while floating in air. In this case, only specular reflection light can be efficiently reflected with respect to a retroreflector by making a divergence angle of the emitted image light small, that is, be an acute angle, and equalizing the image light to have a specific polarized wave. Therefore, the light use efficiency is high, and the ghost image occurring in addition to the main aerial floating image can be suppressed, the ghost image being the issue of the related-art retroreflection method, and thus, a clear aerial floating image can be provided.

By an apparatus including the light source of the present disclosure, a new aerial floating image information display system being capable of significantly reducing power consumption and excellent in availability can be provided. A technique of the present disclosure can provide, for example, an in-vehicle floating image information display system being capable of displaying a visually-recognizable, that is, unidirectionality aerial floating image outside the vehicle through a shield glass including a front windshield glass, a rear windshield glass and a side windshield glass.

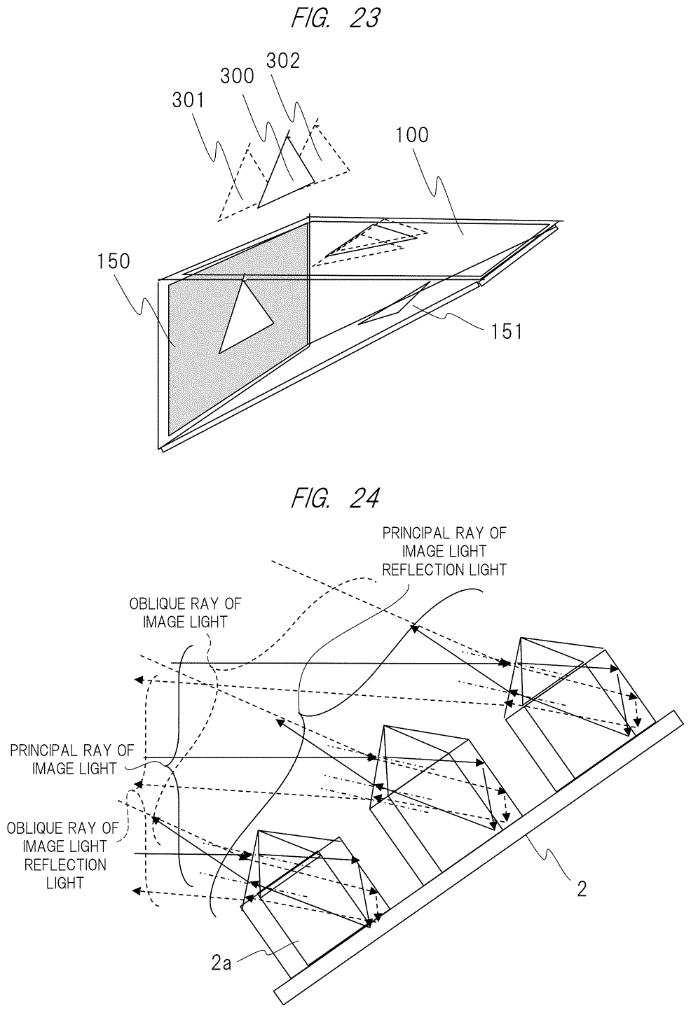

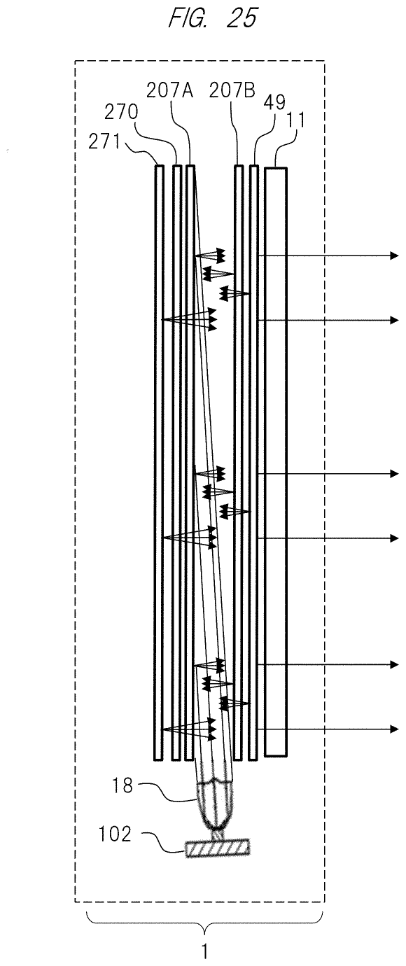

Meanwhile, in the related-art aerial floating image information display system, an organic EL panel or a liquid crystal display panel (liquid crystal panel or display panel) and a retroreflector 151 are combined as a color-display image source 150 having high resolution. In an aerial floating image information display apparatus based on a related art, the image light diffuses at a wide field of view, and therefore, the ghost image (see reference signs 301 and 302 in FIG. 23) is generated by the image light obliquely entering a retroreflector 2a as shown in FIG. 24 in addition to the specular reflection light reflected on the retroreflector 151 (see FIG. 23), and this ghost image reduces a quality of the aerial floating image. In the aerial floating image display apparatus based on the related art, a plurality of images such as a first ghost image 301 and a second ghost image 302 are generated in addition to a specular aerial floating image 300 as shown in FIG. 23. Therefore, other person than a viewing person is undesirably allowed to view the same aerial floating image that is the ghost image, and this case has a large problem in a viewpoint of security.

<First Configuration Example of Aerial Floating Image Information Display System>

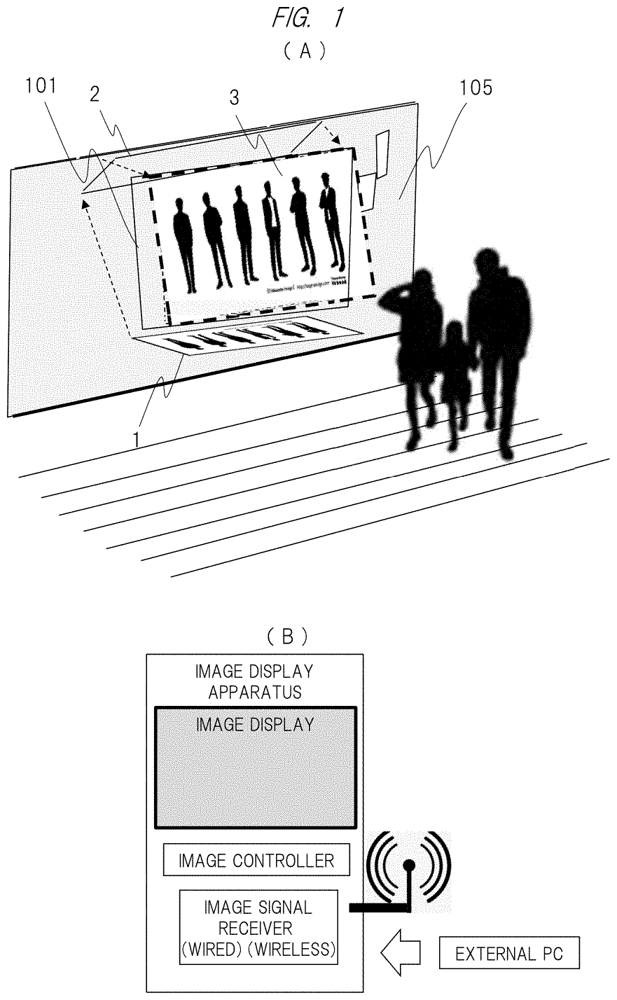

FIG. 1(A) is a diagram showing an example of a use mode of the aerial floating image information display system of the present disclosure. Also, FIG. 1(A) is a diagram for explaining an entire configuration of the aerial floating image information display system of the present embodiment. With reference to FIG. 1(A), for example, the space in the shop or others is partitioned by a show window (also referred to as “window glass”) 105 that is a light transmittable member such as a glass. According to the aerial floating information display system (also referred to as “present system” below) of the present disclosure, the floating image can be transmitted through the transparent member, and be unidirectionally displayed outside the shop (space).

Specifically, according the present system, light having directionality of a narrow angle and specific polarized wave is emitted as an image luminous flux from an image display apparatus (display apparatus) 1, is temporarily caused to enter a retroreflector 2, is transmitted through a window glass 105 after retroreflection, and forms a spatial image 3 (aerial floating image 3) that is an actual image outside the shop. FIG. 1(A) is illustrated so that an inside of the transparent member (in this case, window glass) 105 (that is an inside of the shop) is set as a depth side while an outside (such as sidewalk) of the window glass 105 is set as a front side.

Meanwhile, the window glass 105 may be provided with means for reflecting the specific polarized wave, and the image light flus may be reflected by the means to form the spatial image at a desirable position inside the shop.

FIG. 1B is a block diagram showing a configuration of the image display apparatus 1. The image display apparatus 1 includes an image display portion displaying an original image of the spatial image, an image controller converting the input image in accordance with a resolution of a panel, and an image signal receiver receiving an image signal.

Among these components, the image signal receiver plays a role of handling a wired input signal through an input interlace such as HDMI (High-Definition Multimedia Interface (registered trademark)) and handling a wireless input signal through Wi-Fi (registered trademark) (Wireless Fidelity). And, the image signal receiver can also individually function as an image receiver/display. Further, the image signal receiver can also display the image information output from a tablet, a smartphone or others. Still further, a processor (arithmetic processor) such as a stick PC is connectable to the image signal receiver as necessary. In this case, the entire image signal receiver can be also provided with availability of a calculation processing, an image analysis processing and others.

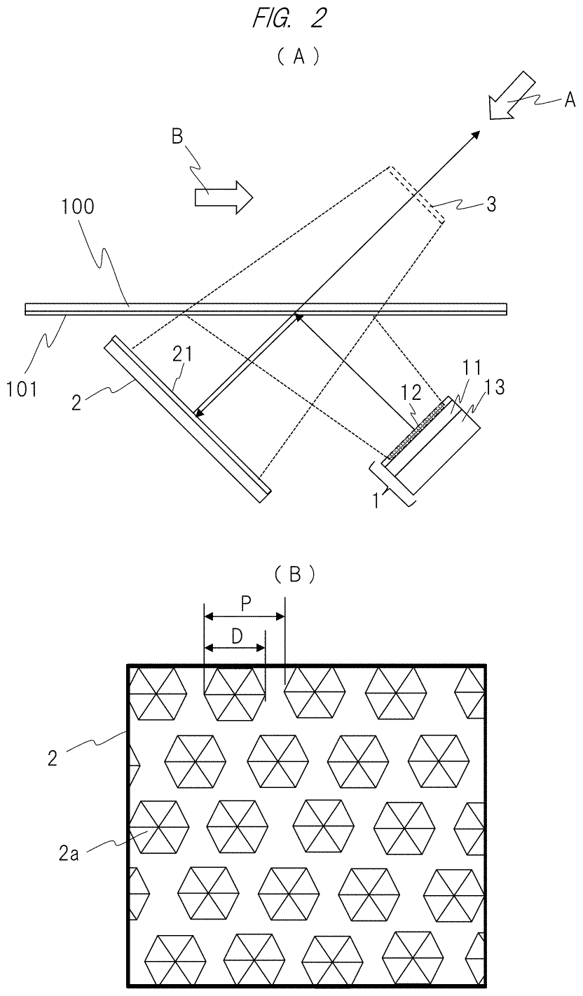

FIG. 2 is a diagram showing an example of a principal-portion configuration and a retroreflection-portion configuration of the aerial floating image information display system of the present disclosure. The configuration of the aerial floating image information display system will be specifically explained with reference to FIG. 2. As shown in FIG. 2(A), the image display apparatus 1 diffusing the image light of the specific polarized wave at a narrow angle is arranged in a tilt direction of a transmittable plate (also referred to as “transparent member” below) 100 such as a glass having a light transmittable property. The image display apparatus 1 includes a liquid crystal display panel 11 and a light source apparatus 13 generating the light of the specific polarized wave having the narrow-angle diffuse property.

The image light of the specific polarized wave emitted from the image display apparatus 1 is reflected by a polarization splitter 101 (in the drawing, a sheet-shaped polarization splitter 101 is adhered to the transparent member 100) having a film that is arranged on the transparent member 100 and selectively reflects the image light of the specific polarized wave, and enters the retroreflector 2. A λ/4 plate 21 is arranged on an image-light entering surface of the retroreflector. The image light is converted in terms of light polarization from the specific polarized wave to another polarized wave when being transmitted through the λ/4 plate 21 twice that is the entering and the emission to/from the retroreflector.

In this case, the polarization splitter 101 that selectively reflects the image light of the specific polarized wave has a property that transmits the polarized light of another polarized wave that has been converted in terms of light polarization, and therefore, the image light of the specific polarized wave that has been converted in terms of light polarization is transmitted through the polarization splitter 101. The image light transmitted through the polarization splitter 101 forms the aerial floating image 3 that is the actual image, outside the transparent member 100.

Note that the light forming the aerial floating image 3 is aggregation of light rays converging from the retroreflector 2 to an optical image of the aerial floating image 3, and these light rays linearly propagate even after penetrating the optical image of the aerial floating image 3. Therefore, the aerial floating image 3 is different from the diffused image light formed on a screen by a general projector, and is an image having high directionality.

Therefore, in the configuration of FIG. 2, the aerial floating image 3 is visually recognized as a bright image when being visually recognized by a user in a direction of an arrow “A”. However, the aerial floating image 3 cannot be visually recognized as an image at all when being visually recognized by a different person in a direction of an arrow “B”. This property is very preferable when being applied to a system displaying an image that needs high security or displaying an image having a high secret level that needs to be secret to a person who faces the user.

Note that light polarization axes of the image light after the reflection are sometimes not equalized depending on a performance of the retroreflector 2. In this case, a part of the image light having the unequal light polarization axes is reflected by the polarization splitter 101, and returns to the image display apparatus 1. This part of the image light is reflected again by an image display surface of the liquid crystal display panel 11 configuring the image display apparatus 1, and forms the ghost image, and therefore, may be a cause of reduction of the image quality of the aerial floating image.

Accordingly, in the present embodiment, the image display surface of the image display apparatus 1 is provided with an absorbance-type light polarizer 12. The absorbance-type light polarizer 12 can suppress the re-reflection by causing the image light emitted from the image display apparatus 1 to be transmitted through the absorbance-type light polarizer 12 and causing the reflection light returning from the polarization splitter 101 to be absorbed by the absorbance-type light polarizer 12. Therefore, according to the present embodiment using the absorbance-type light polarizer 12, the reduction of the image quality of the aerial floating image due to the ghost image can be prevented or suppressed.

The polarization splitter 101 may be made of, for example, a reflection-type light polarizer or a metal multilayer film that reflects the specific polarized wave.

Next, FIG. 2(B) shows a surface shape of a retroreflector produced by Nippon Carbide Industries Co., Inc., used as the typical retroreflector 2 for this study. The light ray entering an orderly-aligned hexagonal prism is reflected on a wall surface and a bottom surface of the hexagonal prism, is emitted as the retroreflection light in a direction corresponding to the incident light, and is displayed as the aerial floating image that is the actual image based on the image displayed on the image display apparatus 1. Resolution of this aerial floating image significantly depends on not only the resolution of the liquid crystal display panel 11 but also an outer shape “D” and a pitch “P” of a retroreflection portion of the retroreflector 2 shown in FIG. 2(B). For example, when a WUXGA liquid crystal display panel of 7 inches (1920×1200 pixels) is used, even if one pixel (one triplet) is about 80 μm, if the diameter D and the pitch of the retroreflection portion are 240 μm and 300 μm, respectively, one pixel of the aerial floating image is equivalent to 300 μm. Therefore, effective resolution of the aerial floating image decreases down to about ⅓. Accordingly, in order to make the resolution of the aerial floating image as equal as the resolution of the image display apparatus 1, it is desirable to make the diameter and the pitch of the retroreflection portion close to one pixel of the liquid crystal display panel. Meanwhile, in order to suppress the moire based on the pixels of the retroreflector and the liquid crystal display panel, each pitch ratio may be designed to deviate from an integral multiple of one pixel. Regarding the shape, all sides of the retroreflection portion may be arranged not to overlap all sides of one pixel of the liquid crystal display panel.

Meanwhile, in order to manufacture the retroreflector at a low cost, the retroreflector may be shaped by a roll press method. Specifically, this method is a method of arranging and forming the retroreflection portion on a film, and this method provides the retroreflector 2 having a desirable shape by forming an inverse shape of the formed shape on a roll surface, applying an ultraviolet curing resin onto a base material for fixation, causing the portion to pass through a gap between the rolls to form the necessary shape, and emitting the ultraviolet ray to it for curing.

<Second Configuration Example of Aerial Floating Image Information Display System>

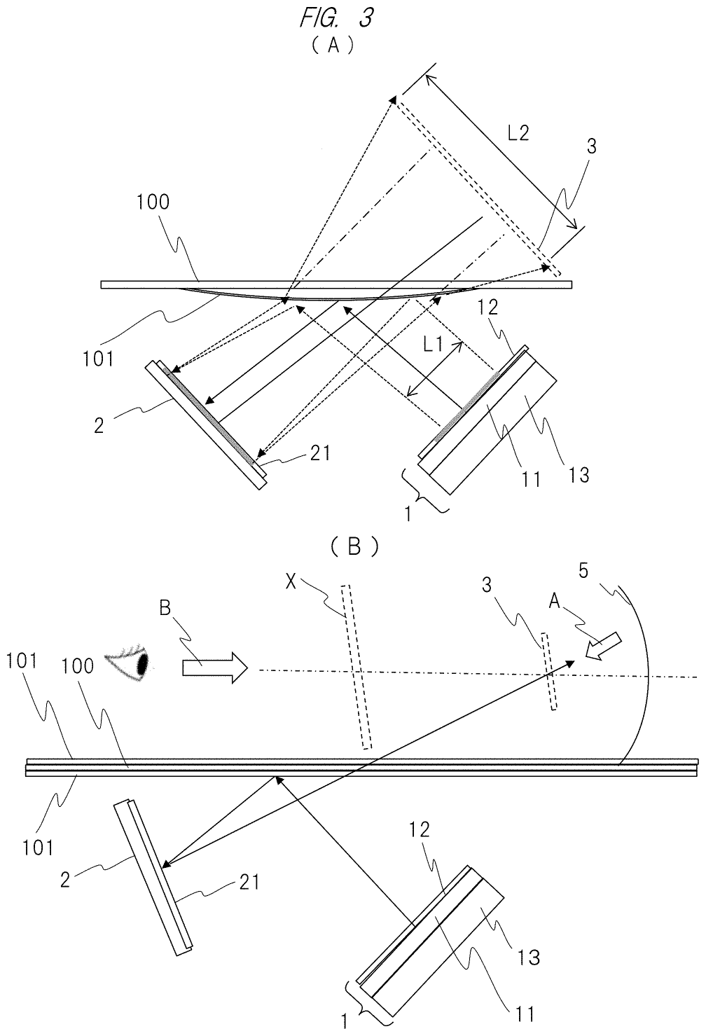

FIG. 3 is a diagram showing another example of the principal-portion configuration of the aerial floating image information display system according to the embodiment of the present invention. FIG. 3(A) is a diagram showing another example of the aerial floating image information display system. The image display apparatus 1 is configured to include the liquid crystal display panel 11 serving as an image display component 11 and a light source apparatus 13 generating the light of the specific polarized wave having the narrow-angle diffuse property. The liquid crystal display panel 11 is made of a liquid crystal display panel having a size ranging from a small screen size of about 5 inches to a large size excessing 80 inches. For example, the image light emitted from the liquid crystal display panel is reflected to the retroreflector (retroreflection portion or retroreflection plate) 2 by the polarization splitter 101 such as the reflection-type light polarizer.

A difference of the example shown in FIG. 3 from the example shown in FIG. 2 is in that a reflection sheet is arranged along a convex surface shape. Therefore, the image light emitted from the liquid crystal display panel 11 is diffused to match with a concave surface shape, and enters the retroreflector 2. As a result, the aerial floating image 3 that is the enlarged actual image wider than the image display screen (the display size of which is shown with “L1” in the drawing) of the liquid crystal display panel 11 can be provided. Further, the image luminous flux having been reflected by the retroreflector 2 is converted in terms of the light polarization, and then, is transmitted through the reflection sheet having the convex surface, is further diffused by a function of the concave surface shape formed on the other surface of the convex surface, is transmitted through the transparent member 100, and forms an aerial floating image “L2” that is enlarged in the tilt direction of FIG. 3(A). In this case, a magnification “M” of the aerial floating image is expressed as “M=L2/L1”.

As described above, an optical member having a lens function is arranged between the image display component 11 and the retroreflector 2 or between the retroreflector 2 and the aerial floating image, and this optical member is eccentrically arranged or tilted from an optical axis connecting the image display apparatus and the retroreflector, and therefore, the size and the image forming position of the aerial floating image generated by the image information system can be optionally set with respect to the optical axis. As described above, when the size and the image forming position of the aerial floating image are changed by the optical member, the aerial image is deformed if any action is not taken. However, if an image with corrected deformation is displayed by the image display apparatus, the image information system can provide the image without the deformation as a whole.

The λ/4 plate 21 is arranged on the light entering surface of the retroreflector 2. When the incident image light is transmitted through the λ/4 plate 21 again after being reflected by the retroreflector 2, the polarized wave of the image light is converted, and the light is transmitted through the polarization splitter 101 having the convex surface. As a result, the aerial floating image having the size different from the size of the image displayed by the liquid crystal display panel can be formed at the position after the penetration through the transparent member 100.

<Third Configuration Example of Aerial Floating Image Information Display System>

FIG. 3(B) is a diagram showing another example of the aerial floating image information display system. As similar to FIG. 3(A), the image display apparatus 1 is configured to include the liquid crystal display panel 11 and the light source apparatus 13 generating the light of the specific polarized wave having the narrow-angle diffuse property. The liquid crystal display panel 11 can be made of a liquid crystal display panel having a size ranging from a small screen size of about 5 inches to a large size excessing 80 inches. For example, the image light emitted from the liquid crystal display panel 11 is reflected to the retroreflector (retroreflection portion or retroreflection plate) 2 by the polarization splitter 101 such as the reflection-type light polarizer that selectively reflects the image light of the specific polarized wave. A difference from the example of FIG. 2 is in that the resultant aerial floating image is enlarged as a virtual image “X” by a concave mirror 5. The configurations of the image display apparatus 1 and the retroreflector 2 are the same as those of the examples shown in FIGS. 2 and 3(A), and therefore, the explanation thereof will be omitted. Further, note that the polarization splitter member 101 in the configuration of FIG. 3(B) may be shaped into a convex surface shape.

In this case, as explained with reference to FIG. 2, the aerial floating image 3 is made of the light ray having the high directionality, and therefore, the aerial floating image 3 is visually recognized as the bright image when being visually recognized in the direction of the arrow A. However, when being visually recognized in the direction of the arrow B, the aerial floating image 3 is not visually recognized as the image at all. Therefore, in the configuration of FIG. 3(B), when the user visually recognizes the aerial floating image 3 in the direction of the arrow B, the aerial floating image 3 is positioned to be deeper than the virtual image X. However, by the user, the aerial floating image 3 is not visually recognized at all while only the virtual image X is favorably visually recognized. Thus, when this property is utilized to make a configuration in which the aerial floating image 3 is positioned to be deeper than the virtual image X as shown in FIG. 3(B), the entire system can be more downsized than in a configuration in which the aerial floating image 3 is positioned to be out of a visual recognition range for a user “X” who visually recognizes the virtual image X, and therefore, the above-described configuration is preferable.

<Fourth Configuration Example of Aerial Floating Image Information Display System>

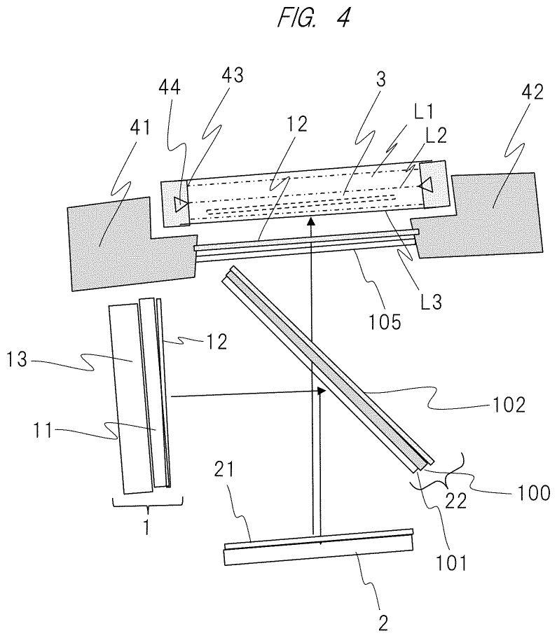

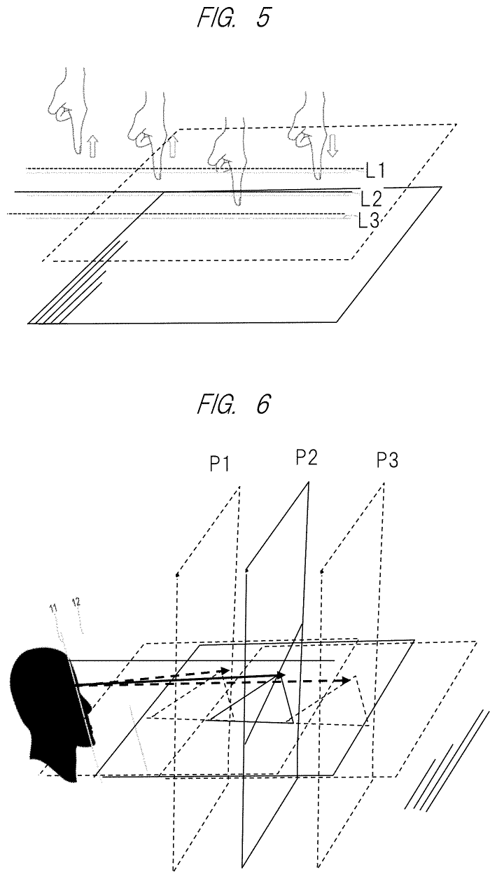

FIG. 4 is a diagram showing another example of the principal-portion configuration of the aerial floating image information display system according to the embodiment of the present invention. As similar to FIG. 3(A) and others, the image display apparatus 1 is configured to include the liquid crystal display panel 11 and the light source apparatus 13 generating the light of the specific polarized wave having the narrow-angle diffuse property. The liquid crystal display panel 11 is made of, for example, a liquid crystal display panel having a size ranging from a small screen size of about 5 inches to a large size excessing 80 inches. In a return mirror 22, the transparent member 100 is used as a substrate. A surface of the transparent member 100, the surface being close to the image display apparatus 1, is provided with the polarization splitter 101 such as the reflection-type light polarizer that selectively reflects the image light of the specific polarized wave, and reflects the image light emitted from the liquid crystal display panel 11 to the retroreflector 2. Therefore, the return mirror 22 has a function of a mirror. The image light of the specific polarized wave emitted from the image display apparatus 1 is reflected by the polarization splitter 101 arranged on a lower surface of the transparent member 100 (that is, in the illustrated example, the sheet-shaped polarization splitter 101 is adhered to the transparent member 100 by an adhesive), and enters the retroreflector 2. In place of the polarization splitter 101, note that an optical film having a polarization split property may be deposited on the surface of the transparent member 100.

The light entering surface of the retroreflector 2 is provided with the λ/4 plate 21, and, when transmitting the image light therethrough twice, converts the image light in terms of the light polarization so that the specific polarized wave is converted to another polarized wave having a phase that is different by 90°. In this manner, the image light after the retroreflection is transmitted through the polarization splitter 101, and the aerial floating image 3 that is the actual image is displayed outside the transparent member 100. In this case, the light polarization axes in the polarization splitter 101 are not equalized because of the retroreflection, and therefore, a part of the image light is reflected and returns to the image display apparatus 1. This light component is reflected again by the image display surface of the liquid crystal display panel 11 configuring the image display apparatus 1, generates the ghost image, and significantly reduces the image quality of the aerial floating image.

Accordingly, in the present example, the image display surface of the image display apparatus 1 is provided with the absorption-type light polarizer 12. This absorption-type light polarizer 12 transmits the image light emitted from the image display apparatus 1 while absorbing the reflection light emitted from the polarization splitter 101. By such a configuration, the reduction of the image quality of the aerial floating image due to the ghost image is prevented. Also, in order to suppress the reduction of the image quality due to sunlight or illumination light outside the set, a surface of a transparent member 105, the surface being close to the image light output side, may be provided with an absorption-type light polarizer 102.

Next, in order to sense a distance between a sensor 44 and an object and its positional relation in the aerial floating image provided by the above-described aerial floating image information system, the sensor 44 having a TOF (Time of Fly) function is arranged in a plurality of layers as shown in FIG. to achieve the sensing of not only coordinates of the object in the planar direction but also coordinates of the object in the depth direction and a moving direction and a moving speed of the object.

In order to recognize two-dimensional distance and position, a plurality of combinations of a light receiver and a non-visible light emitter of light such as infrared ray or ultraviolet ray are linearly arranged to emit the light having been emitted from a light emission point toward the object, and the reflected light is received by the light receiver. The distance to the object is made clear by a product of light speed and a difference between time of the light emission and time of the light reception. The in-plane coordinates can be recognized from coordinates of a position having the smallest difference between the time of the light emission and the time of the light reception among the plurality of the light receivers and the light emitters. In this manner, three-dimensional coordinates information can be also recognized from a plurality of combinations of the sensors and the in-plane (two-dimensional) coordinates of the object.

Further, a method of providing a three-dimensional aerial floating image in the aerial floating image information system will be explained with reference to FIG. 6. FIG. 6 is a diagram for explaining a principle of three-dimensional image display used in the aerial floating image information display system. A horizontal lenticular lens is arranged in accordance with a pixel of the image display screen of the liquid crystal display panel 11 of the image display apparatus 1 shown in FIG. 4. As a result, in order to display motion parallax in three directions of movement parallax P1, P2 and P3 in the horizontal direction of the screen as shown in FIG. 6, images in the three directions are handled as one block for each three pixels, image information in the three direction is displayed for each pixel, the light emission direction is adjusted by a function of the corresponding lenticular lens (illustrated with a vertical line in FIG. 6), and the light is diffusely emitted in the three directions. As a result, a three-dimensional image of three parallax can be displayed.

<Reflection-Type Light Polarizer>

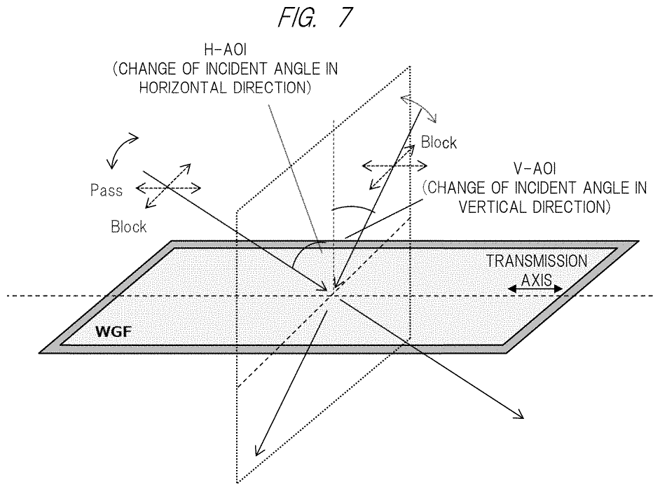

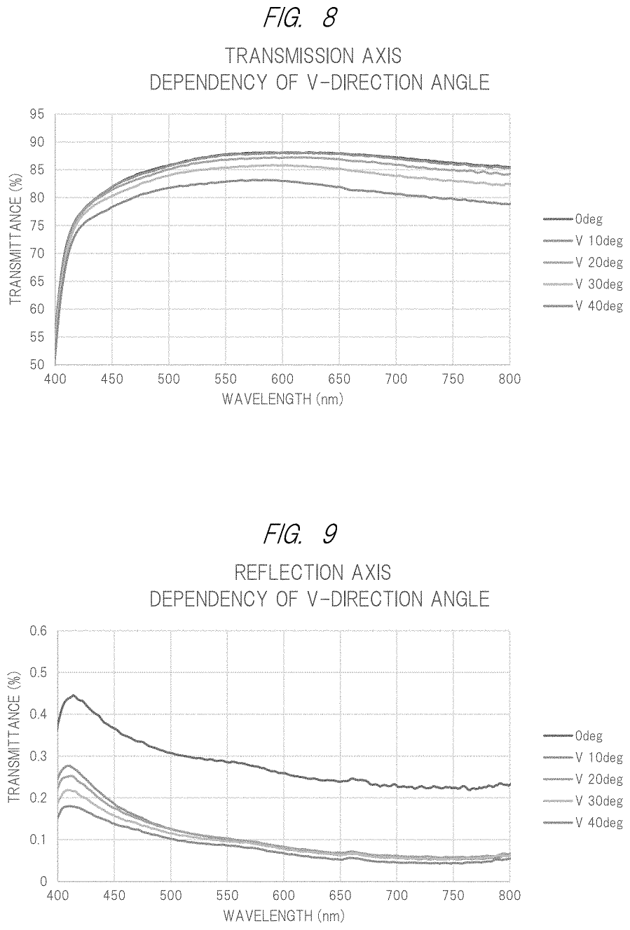

In the aerial floating image information apparatus of the present example, the polarization splitter 101 is used for more improvement of the contrast performance defining the image quality than that of a regular half mirror. A property of the reflection-type light polarizer will be explained as one example of the polarization splitter 101 of the present example. FIG. 7 is an explanatory diagram of a measuring system for evaluating the property of the reflection-type light polarizer. As “V-AOI”, each of FIGS. 8 and 9 shows a transmitting property and a reflecting property at a light ray incident angle in a direction vertical to the light polarization axis of the reflection-type light polarizer of FIG. 7. Similarly, as “H-AOI”, each of FIGS. and 11 shows a transmitting property and a reflecting property at a light ray incident angle in a direction horizontal to the light polarization axis of the reflection-type light polarizer.

In characteristic graphs (each illustrated with color) of FIGS. 8 to 11, angle values (deg) on a right side out of a frame are shown in an ascending order of a value of a vertical axis, that is, a value of the transmittance (%) from an upper side. For example, in FIG. 8, in a range of a horizontal axis showing light having a wave length of about 400 to 800 nm, a case of the angle of 0 (deg) in the vertical (V) direction has the highest transmittance, and the transmittance decreases in an order of the angle of 10 degrees, 20 degrees, 30 degrees and 40 degrees. In FIG. 9, in a range of a horizontal axis showing light having a wave length of about 400 to 800 nm, a case of the angle of 0 (deg) in the vertical (V) direction has the highest transmittance, and the transmittance decreases in an order of the angle of 10 degrees, 20 degrees, 30 degrees and 40 degrees.

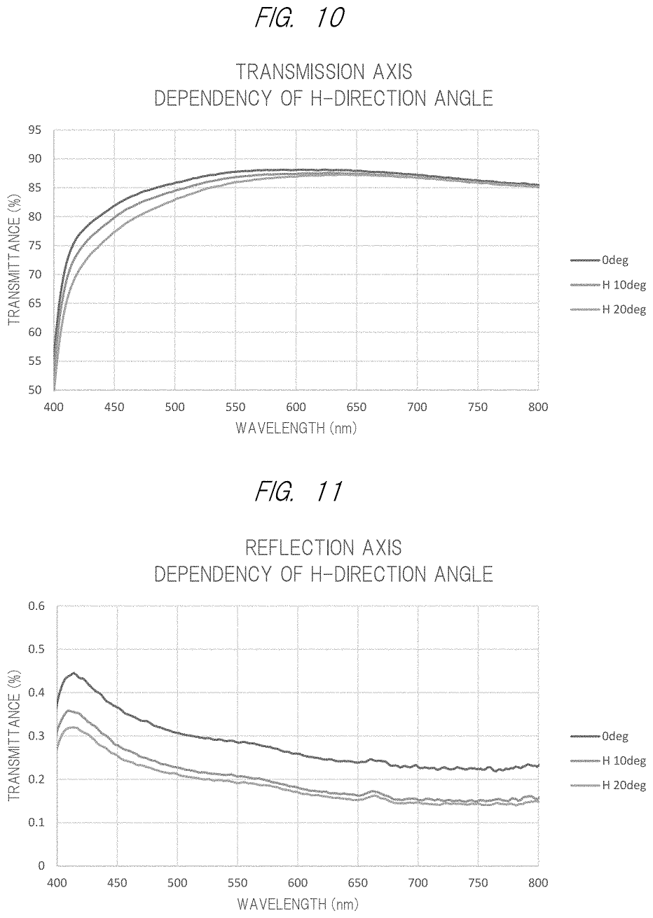

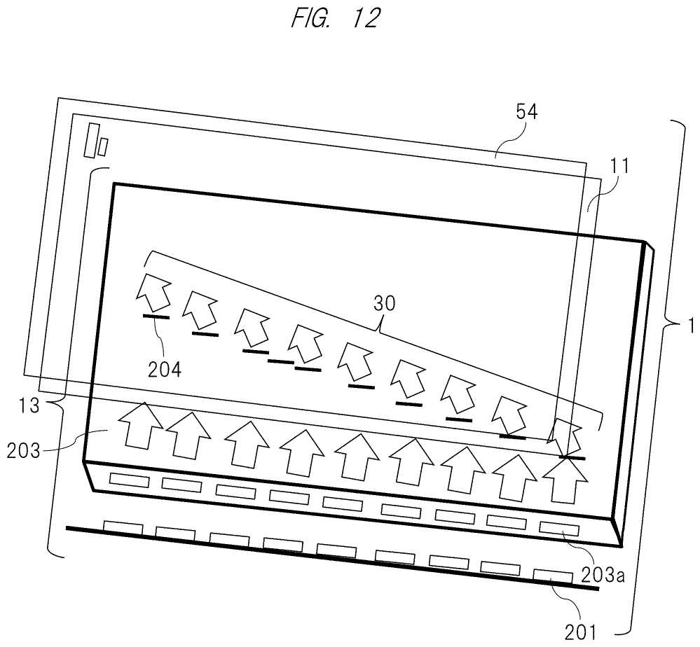

In FIG. 10, in a range of a horizontal axis showing light having a wave length of about 400 to 800 nm, a case of the angle of 0 (deg) in the horizontal (H) direction has the highest transmittance, and the transmittance decreases in an order of the angle of 10 degrees and 20 degrees. In FIG. 11, in a range of a horizontal axis showing light having a wave length of about 400 to 800 nm, a case of the angle of 0 (deg) in the horizontal (H) direction has the highest transmittance, and the transmittance decreases in an order of the angle of 10 degrees and 20 degrees.

As shown in FIGS. 8 and 9, in a reflection-type light polarizer having a grid structure, the property for the light in the direction vertical to the light polarization axis decreases. Therefore, specifications along the light polarization axis are desirable, and the light source of the present example capable of emitting the image light at the narrow angle, the light having been emitted from the liquid crystal display panel 11, is an ideal light source. For the light in the tilt direction, the property in the horizontal direction similarly decreases. In consideration of the above-described properties, a configurational example of the present example using the light source capable of emitting the image light at the narrow angle, the light having been emitted from the liquid crystal display panel 11, as a backlight of the liquid crystal display panel 11 will be explained below. In this manner, the high-contrast aerial floating image can be provided.

<Image Display Apparatus>

Next, the image display apparatus 1 of the present example will be explained with reference to drawings. The image display apparatus of the present example includes the image display component 11 (liquid crystal display panel) and the light source apparatus 13 configuring its light source. FIG. 12 shows the light source apparatus 13 together with the liquid crystal display panel in an exploded transparent view.

As shown with an arrow 30 in FIG. 12, in this liquid crystal display panel (image display component 11), the luminous flux having the narrow-angle diffuse property, that is the illumination luminous flux having the property similar to the laser beam having the intense directionality (straightness) and the unidirectionally-equalized light polarization surface is formed from the light emitted from the light source apparatus 13 that is the backlight apparatus, the image light modulated in accordance with the input image signal is reflected by the retroreflector 2 and is transmitted through the window glass 105, and the aerial floating image that is the actual image is formed (also see FIG. 1).

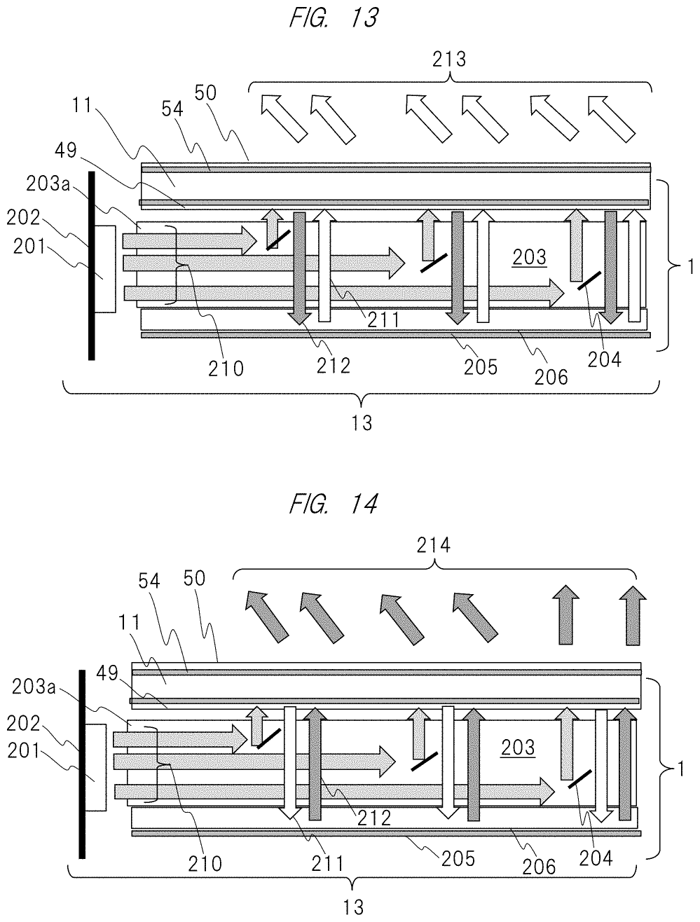

The configuration of FIG. 12 includes not only the liquid crystal display panel 11 configuring the image display apparatus 1 but also a light-direction converting panel 54 for adjusting the directionality of the luminous flux emitted from the light source apparatus 13, and a narrow-angle diffuse plate (not illustrated) as necessary. In other words, in the configuration, the light polarizer is arranged on both surface of the liquid crystal display panel 11 to adjust the light intensity of the image light of the specific polarized wave in accordance with the image signal, and the light is emitted (see the arrow 30 in FIG. 12). In this manner, a desirable image is projected as the light of the specific polarized wave having the high directionality (straightness) to the retroreflector 2 through the light-direction converting panel 54, and is reflected by the retroreflector 2, and then, is transmitted toward eyes of the viewing person outside the shop (space), and forms the aerial floating image 3. Note that a protection cover 50 (see FIGS. 13 and 14) may be arranged on a surface of the light-direction converting panel 54.

In the present example, in order to improve the use efficiency of the luminous flux 30 emitted from the light source apparatus 13 to significantly reduce the power consumption, in the image display apparatus 1 configured to include the light source apparatus 13 and the liquid crystal display panel 11, the light (see the arrow 30 in FIG. 12) emitted from the light source apparatus 13 can be projected toward the retroreflector 2, and can be reflected by the retroreflector 2, and then, the directionality can be adjusted to form the floating image at the desirable position by using a transparent sheet (not illustrated) arranged on the surface of the window glass 105.

Specifically, in this transparent sheet, the floating-image forming position is adjusted with the high directionality by an optical component such as a Fresnel lens and a linear Fresnel lens. In this manner, the image light emitted from the image display apparatus 1 and having the high directionality (straightness) such as laser beam efficiently reaches the viewing person outside the window glass 105 (such as on the sidewalk). As a result, the high-quality floating image with the high resolution can be displayed, and the power consumption of the image display apparatus 1 including the LED element 201 of the light source apparatus 13 can be significantly reduced.

<First Example of Image Display Apparatus>

FIG. 13 shows an example of a specific configuration of the image display apparatus 1. In FIG. 13, the liquid crystal display panel 11 and the light-direction converting panel 54 are arranged above the light source apparatus 13 of FIG. 12. This light source apparatus 13 made of, for example, plastic or others is formed on a case shown in FIG. 12, and is configured to house an LED element 201 and a light guiding body 203 therein. As shown in FIG. 12 and others, in order to convert the divergence light emitted from each LED element 201 to be substantially collimated luminous flux, an end surface of the light guiding body 203 has a cross-sectional area gradually increasing toward a surface facing the light receiver to form a lens shape having a function of making the divergence angle gradually small through a plurality of total reflections in internal propagation.

The liquid crystal display panel 11 is attached onto the light guiding body 203. The LED (Light Emitting Diode) element 201 that is a semiconductor light source and an LED board 202 on which a control circuit for the element is mounted may be attached to one side surface (in this example, a left end surface) of the case of the light source apparatus 13, and a heat sink that is a member for cooling the heat generated in the LED element and the control circuit may be attached to an outer surface of the LED board 202.

To a frame (not illustrated) of the liquid crystal display panel 11 attached to an upper surface of the case of the light source apparatus 13, the liquid crystal display panel 11 attached to this frame, a FPC (Flexible Printed Circuits: flexible wiring board) (not illustrated) electrically connected to this liquid crystal display panel 11 and others are attached. In other words, the liquid crystal display panel 11 that is the image display component generates the display image in corporation with the LED element 201 that is a solid light source by modulating an intensity of the transmission light on the basis of a control signal output from a control circuit (not illustrated) configuring the electronic device. In this case, the generated image light has the narrow diffuse angle, and is made of only the specific polarized wave component, and therefore, a new image display apparatus that is approximately a surface emission laser image source driven based on the image signal and that is different from the related art can be provided.

Currently, note that it is technically and safely impossible to cause a laser apparatus to provide the laser luminous flux having the same size as that of the image provided by the image display apparatus 1. Accordingly, in the present embodiment, the light that is approximately the surface emission laser image light is formed from the luminous flux emitted from, for example, a general light source including an LED element.

Subsequently, a configuration of the optical system housed in the case of the light source apparatus 13 will be explained in detail with reference to FIG. 14 in addition to FIG. 13.

Since each of FIGS. 13 and 14 is a cross-sectional view, only one of a plurality of LED elements 201 configuring the light source is illustrated. Light from these components is converted to substantially collimated light by a shape of a light receiving end surface 203a of the light guiding body 203. Therefore, the light receiver and the LED element on the end surface of the light guiding body are attached so as to keep a predetermined positional relation.

Note that each light guiding body 203 is made of, for example, a light-transmittable resin such as acrylic resin. The LED light receiving surface of the end of the light guiding body 203 has, for example, a conically convex outer circumferential surface formed by rotation of a paraboloid cross section, its apex has a concave portion with a convex center (in other words, a convex lens surface), and center of its plane portion has a convex lens surface (not illustrated) that protrudes outward (or may be a concave lens surface that is recessed inward). Note that the outer shape of the light receiver of the light guiding body to which the LED element 201 is attached is the paraboloid shape forming the conically-shaped outer circumferential surface, and is set within a range of an angle allowing the light peripherally emitted from the LED element to be totally reflected inside, or forms the reflection surface.

Meanwhile, the LED element 201 is arranged at each of predetermined positions on the surface of the LED board 202 that is its circuit board. The LED board 202 is arranged and fixed so that each LED element 201 on its surface is positioned at center of the concave portion to correspond to the collimator (light receiving end surface 203a).

In such a configuration, the light emitted from the LED element 201 can be extracted to be the substantially collimated light by the shape of the light receiving end surface 203a of the light guiding body 203, and the use efficiency of the generated light can be improved.

As described above, the light source apparatus 13 is configured so that the light source unit including the plurality of LED elements 201 that are the light source are attached to the light receiving end surface 203a that is the light receiver on the end surface of the light guiding body 203, and the luminous flux emitted from the LED elements 201 is formed to be the substantially collimated light by the lens shape of the light receiving end surface 203a on the end surface of the light guiding body, is guided to propagate in the light guiding body 203 (a direction in parallel to the drawing sheet), and is emitted toward the liquid crystal display panel 11 (in a frontward direction perpendicular to the drawing sheet) arranged in substantially parallel to the light guiding body 203 by a luminous-flux direction converting means 204. Since the distribution (density) of the luminous-flux direction converting means 204 is optimized by a shape of the inside or the surface of the light guiding body, the equalization of the luminous flux entering the liquid crystal display panel 11 can be adjusted.

In the luminous-flux direction converting means 204, when the surface shape of the light guiding body or the inside of the light guiding body is provided with, for example, portions having a different refractive index as shown in FIG. 13 or 14, the luminous flux propagating inside the light guiding body 203 is emitted toward the liquid crystal display panel 11 (in the frontward direction perpendicular to the drawing sheet) arranged in substantially parallel to the light guiding body 203. This case is practically acceptable if the relative luminance ratio is equal to or higher than 20% when the luminance is compared between the center of the screen and the peripheral portion of the screen in a state in which the liquid crystal display panel 11 normally faces at the center of the screen while a point of view is placed at the same position as that of a diagonal dimension of the screen, and the relative luminance ratio that is higher than 30% is the further excellent property.

Note that FIG. 13 is a cross-sectional layout for explaining the configuration of the light source of the present embodiment and its function that performs the light polarization conversion in the light source apparatus 13 including the light guiding body 203 and the LED element 201. In FIG. 13, the light source apparatus 13 includes the light guiding body 203 including the luminous-flux direction converting means 204 being made of, for example, plastic or others on its surface or inside, the LED element 201 functioning as the light source, the reflection sheet 205, the waveplate 206, the lenticular lens and others, and the liquid crystal display panel 11 including the light polarizer on the light-source light entering surface and the image-light emission surface is attached to the upper surface of the light source apparatus.

The light-source light entering surface (the lower surface in the drawing) of the liquid crystal display panel 11 corresponding to the light source apparatus 13 is provided with a film-form or sheet-form reflection-type light polarizer 49, selectively reflects one polarized wave (such as P wave) of the natural luminous flux 210 emitted from the LED element 201 to reflect it by the reflection sheet 205 on one surface (the lower side in the drawing) of the light guiding body 203, and guides it toward the liquid crystal display panel 11 again. Accordingly, the waveplate (λ/4 waveplate) is arranged between the reflection sheet 205 and the light guiding body 203 or between the light guiding body 203 and the reflection-type light polarizer 49, the luminous flux is converted from the P-polarizing light to the S-polarizing light by being reflected by the reflection sheet 205 to propagate twice, and the use efficiency of the light-source light functioning as the image light is improved.

The image luminous flux (shown with an arrow 213 in FIG. 13), the light intensity of which has been modulated in the liquid crystal display panel 11 in accordance with the image signal, enters the retroreflector 2, is reflected, and then, is transmitted through the window glass 105 as shown in FIG. 1, and can provide the aerial floating image that is the actual image inside or outside the shop (space).

As similar to FIG. 13, FIG. 14 is a cross-sectional layout for explaining the configuration of the light source of the present embodiment and its function that performs the light polarization conversion in the light source apparatus 13 including the light guiding body 203 and the LED element 201. The light source apparatus 13 similarly includes the light guiding body 203 including the luminous-flux direction converting means 204 made of, for example, plastic or others on its surface or inside, the LED element 201 functioning as the light source, the reflection sheet 205, the waveplate 206, the lenticular lens and others. Onto the light guiding body 203, the liquid crystal display panel 11 including the light polarizer on the light-source light entering surface and the image-light emission surface is attached as the image display element.

The light-source light entering surface (the lower surface in the drawing) of the liquid crystal display panel 11 corresponding to the light source apparatus 13 is provided with a film-form or sheet-form reflection-type light polarizer 49, selectively reflects one polarized wave (such as S wave) of the natural luminous flux 210 emitted from the LED element 201 to reflect it by the reflection sheet 205 on one surface (the lower side in the drawing) of the light guiding body 203, and guides it toward the liquid crystal display panel 11 again. The waveplate (λ/4 waveplate) is arranged between the reflection sheet 205 and the light guiding body 203 or between the light guiding body 203 and the reflection-type light polarizer 49, the luminous flux is converted from the S-polarizing light to the P-polarizing light by being reflected by the reflection sheet 205 to propagate twice, and the use efficiency of the light-source light functioning as the image light is improved. The image luminous flux (shown with an arrow 214 in FIG. 14), the light intensity of which has been modulated in the liquid crystal display panel 11 in accordance with the image signal, enters the retroreflector 2, is reflected, and then, is transmitted through the window glass 105 as shown in FIG. 1, and can provide the aerial floating image that is the actual image inside or outside the shop (space).

In the light source apparatus shown in FIGS. 13 and 14, since the one polarized wave component is reflected by the reflection-type light polarizer 49 in addition to the function of the light polarizer arranged on the light entering surface of the corresponding liquid crystal display panel 11, a theoretical contrast ratio is calculated from multiplication of an inverse number of a cross transmittance of the reflection-type light polarizer and a cross transmittance caused by the two light polarizers attached to the liquid crystal display panel. Therefore, the high contrast performance is provided. Practically, from experiments, it has been confirmed that the contrast performance of the display image improves by ten or more times. As a result, the image with the high quality being equivalent to that of a self-luminous-type organic EL is provided.

<Second Example of Image Display Apparatus>

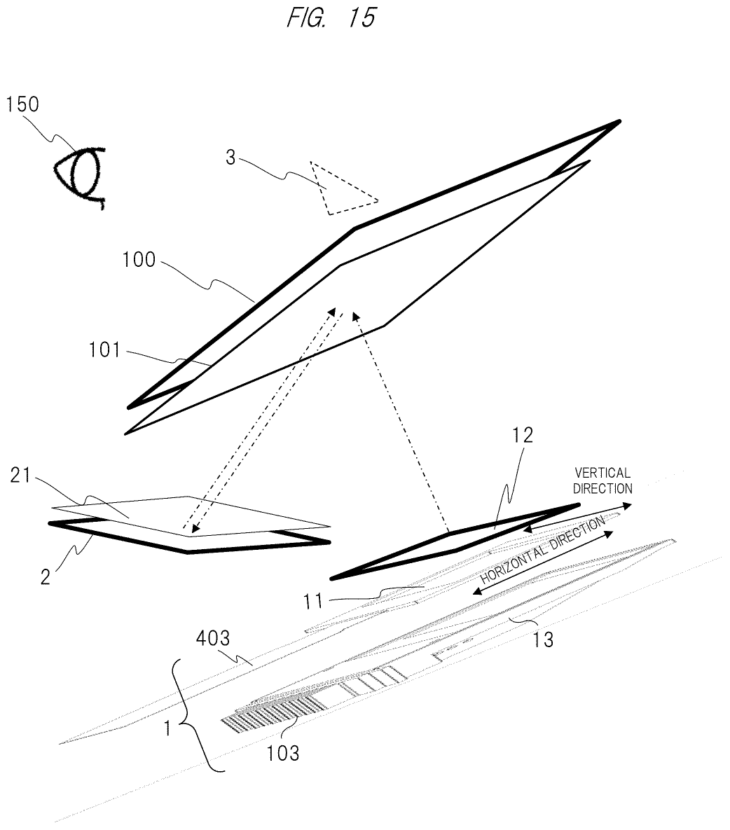

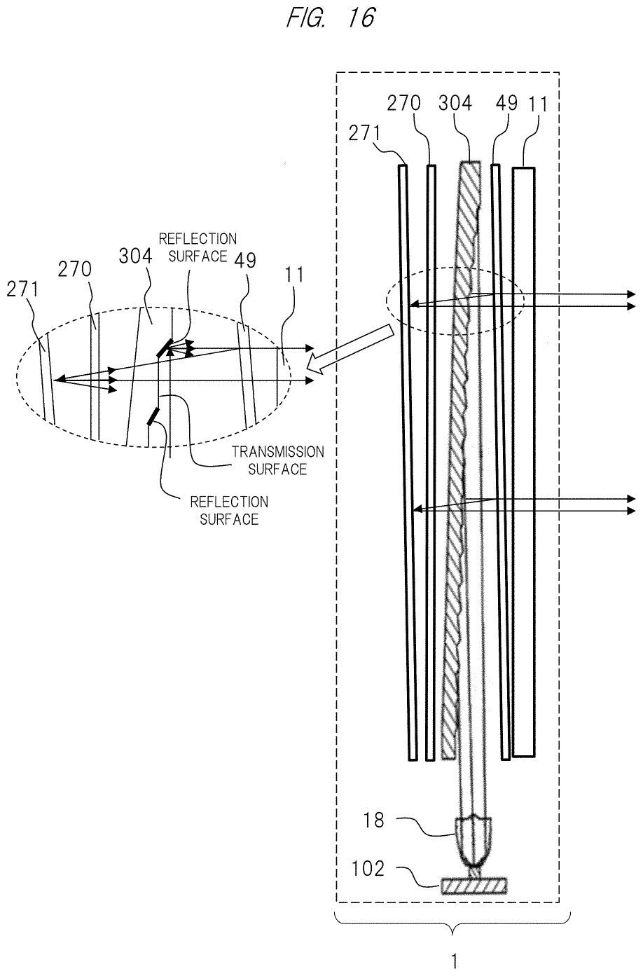

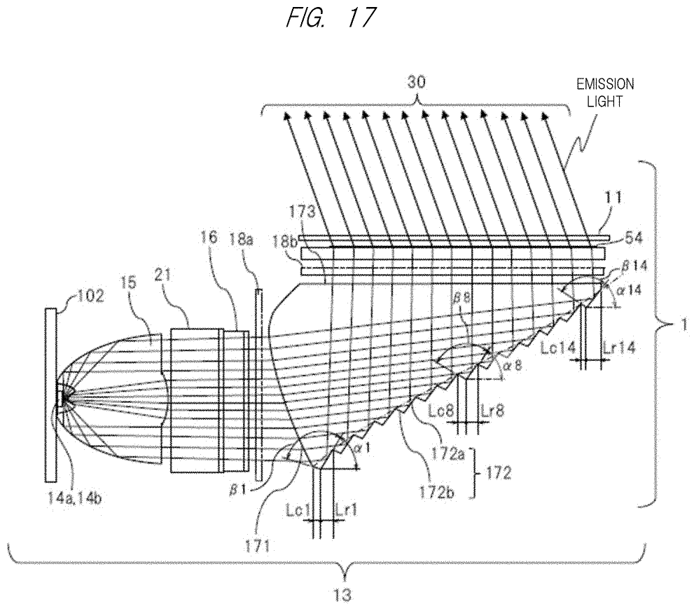

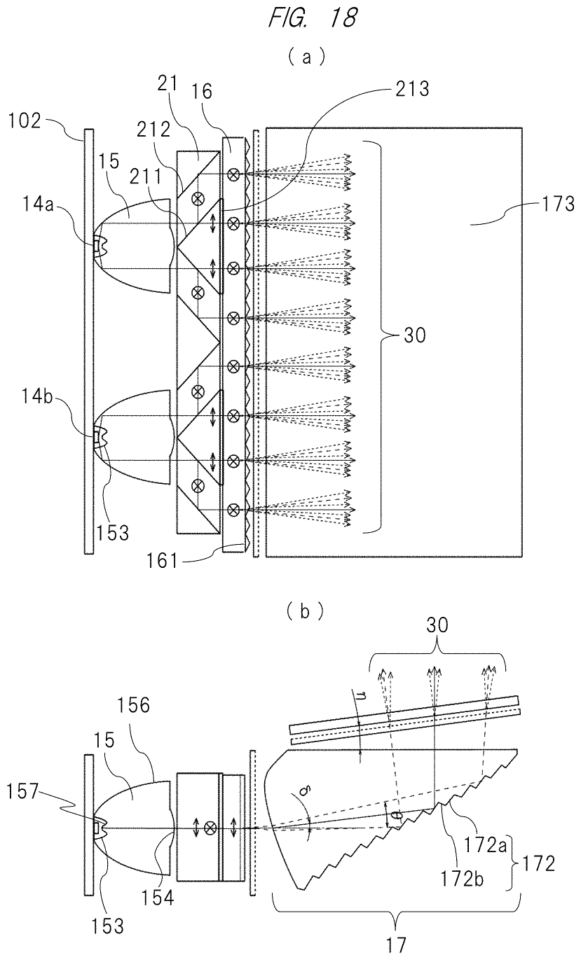

FIG. 15 shows another example of the specific configuration of the image display apparatus 1. The light source apparatus 13 of FIG. 15 is similar to the light source apparatus of FIG. 17 or others. This light source apparatus 13 is configured so that an LED, a collimator, a composite/diffusion block, a light guiding body and others are housed in a case made of, for example, plastic or others, and the liquid crystal display panel 11 is attached to an upper surface of the light source apparatus. The LED (Light Emitting Diode) elements 14a and 14b that are semiconductor light sources and an LED board on which a control circuit for the elements is mounted are attached to one side surface of the case of the light source apparatus 13, and a heat sink 103 that is a member for cooling the heat generated in the LED elements and the control circuit is attached to an outer surface of the LED board (also see FIGS. 17 and 18 and others).

To a frame of the liquid crystal display panel attached to the upper surface of the case, the liquid crystal display panel 11 attached to this frame, a FPC (Flexible Printed Circuits: flexible wiring board) 403 (see FIG. 7) electrically connected to this liquid crystal display panel 11 and others are attached. In other words, the liquid crystal display panel 11 that is the liquid crystal display component generates the display image in corporation with the LED elements 14a and 14b that are solid light sources by modulating an intensity of the transmission light on the basis of a control signal output from a control circuit (not illustrated) configuring the electronic device.

<First Example of Light Source Apparatus of Second Example of Image Display Apparatus>

Subsequently, a configuration of an optical system of the light source apparatus 13 housed in the case or others will be explained in detail with reference to FIGS. 18(a) and 18(b) in addition to FIG. 17.

FIGS. 17 and 18 show the LEDs 14a and 14b configuring the light source, and are attached to predetermined positions of the collimator 15. Note that each collimator 15 is made of, for example, a light-transmittable resin such as acrylic resin. As shown in FIG. 18(b), the collimator 15 has a conically convex outer circumferential surface 156 formed by rotation of a paraboloid cross section, and has a concave portion 153 with a convex center (in other words, a convex lens surface) 157 at its apex (close to the LED board).

A center of a plane portion (an opposite side of the apex) of the collimator 15 has a convex lens surface that protrudes outward (or may be a concave lens surface that is recessed inward) 154. Note that the paraboloid surface 156 forming the conically-shaped outer circumferential surface of the collimator 15 is set within a range of an angle allowing the light peripherally emitted from the LED elements 14a and 14b to be totally reflected inside, or forms the reflection surface.

The LEDs 14a and 14b are arranged at predetermined positions, respectively, on the surface of the LED board 102 that is its circuit board. The LED board 102 is arranged and fixed so that each of the LED elements 14a and 14b on the surface is positioned at center of the concave portion 153 to correspond to the collimator 15.

In such a configuration, among the light emitted from the LED element 14a or 14b, particularly the light emitted upward (in the right direction in the drawing) from its center is collected to form the substantially collimated light by the two convex lens surfaces 157 and 154 forming the outer shape of the collimator 15. The light peripherally emitted from other portions is reflected by the paraboloid surface forming the conically-shaped outer circumferential surface of the collimator 15, and is similarly collected to form the substantially collimated light. In other words, almost all the light components generated by the LED 14a or 14b can be extracted to be the collimated light by the collimator 15 having the convex lens formed on its center and the paraboloid surface formed on the peripheral portion, and the use efficiency of the generated light can be improved.

Note that a light emission region of the collimator 15 is provided with the polarization converter element 21. The polarization converter element 21 may be also called polarization converter. As clearly seen from FIG. 18, the polarization converter element 21 is made of combination of a pillar-shaped light transmittable member having a parallelogram cross section (referred to as parallelogram pillar below) and a pillar-shaped light transmittable member having a triangle cross section (referred to as triangle pillar below), and a plurality of these elements are arranged in an array form in parallel to a surface orthogonal to an optical axis of the collimated light emitted from the collimator 15. Further, a polarization splitter (abbreviated as “PBS film” below) 211 and a reflection film 212 are alternately arranged at a boundary between the adjacent light transmittable members that are arranged in the array form. The emission surface from which the light having entered the polarization converter element 21 and being transmitted through the PBS film 211 is emitted is provided with a λ/2 waveplate 213.

The emission surface of the polarization converter element 21 is further provided with the rectangular composite/diffusion block 16 as shown in FIG. 18(a). In other words, the light emitted from the LED 14a or 14b is formed as the collimated light by the function of the collimator 15, enters the composite/diffusion block 16, and is diffused by a texture 161 on the emission side, and then, reaches the light guiding body 17.

The light guiding body 17 is a member made of a light transmittable resin such as acrylic resin and shaped in a bar having a substantially triangle cross section (see FIG. 18(b)), and, as clearly seen from FIG. 17, has a light-guiding-body light entering portion (surface) 171 facing an emission surface of the composite/diffuse block 16 to interpose a first diffuse plate 18a therebetween, a light-guiding-body light reflecting portion (surface) 172 forming a tilt surface, and a light-guiding-body light emitting portion (surface) 173 facing the liquid crystal display panel 11 that is the liquid crystal display component to interpose a second diffuse plate 18b therebetween.

As shown in FIG. 17 that is a partial enlarged view of the light-guiding-body light reflecting portion (surface) 172, on the light-guiding-body light reflecting portion (surface) 172 of the light guiding body 17, a lot of reflection surfaces 172a and joint surfaces 172b are alternately formed in a saw-teeth form. And, “an” (n: a natural number of, for example, 1 to 130 in the present example) is formed by the reflection surface 172a (a right upward line component in the drawing) and a horizontal surface shown with a dashed dotted line in the drawing. As its one example, “an” is set to be equal to or smaller than 43 degrees (but equal to or larger than 0 degree) here.

On the other hand, the light-guiding-body light entering portion (surface) 171 of the light guiding body 17 is formed to have a curved convex shape tilting toward the light source.

In the light source apparatus 13 having the above-described configuration, the collimated light emitted from the light emission surface of the composite/diffuse block 16 is diffused through the first diffuse plate 18a, and enters the light-guiding-body light entering portion (surface) 171 of the light guiding body 17. As clearly seen from FIG. 17, the light having entered the light guiding body 17 reaches the light-guiding-body light reflecting portion (surface) 172 while slightly bending (being polarized) upward when entering the light-guiding-body light entering portion (surface) 171, is reflected by a reflection surface (172a) of the light-guiding-body light reflecting portion (surface) 172, and reaches the liquid crystal display panel 11 arranged on the light emission surface on the upper side of FIG. 17.

According to the image display apparatus 1 descried in detail above, the light use efficiency and the equalized illumination property can be more improved, and the apparatus including the modularized light source apparatus for the S-polarized wave can be manufactured at a low cost to be downsized. In the above-described explanation, note that the polarization converter element 21 is attached at a subsequent stage of the collimator 15. The present invention is not limited to this arrangement. Arrangement in a light path extending to the liquid crystal display panel 11 can also provide the same function and effect.

A lot of reflection surfaces 172a and joint surfaces 172b are alternately formed in the saw-teeth form on the light-guiding-body light reflecting portion (surface) 172. The illumination luminous flux is totally reflected on each reflection surface 172a, and propagates upward, and besides, enters the light-direction converting panel 54 for adjusting the directionality as the substantially collimated diffuse luminous flux by the narrow-angle diffuse plate arranged on the light-guiding-body light emission portion (surface) 173, and enters the liquid crystal display panel 11 in an oblique direction. In the present example, the light-direction converting panel 54 is arranged between the light-guiding-body light emission surface 173 and the liquid crystal display panel 11. However, its arrangement on the emission surface of the liquid crystal display panel 11 can also provide the same effect.

<Second Example of Light Source Apparatus of Second Example of Image Display Apparatus>

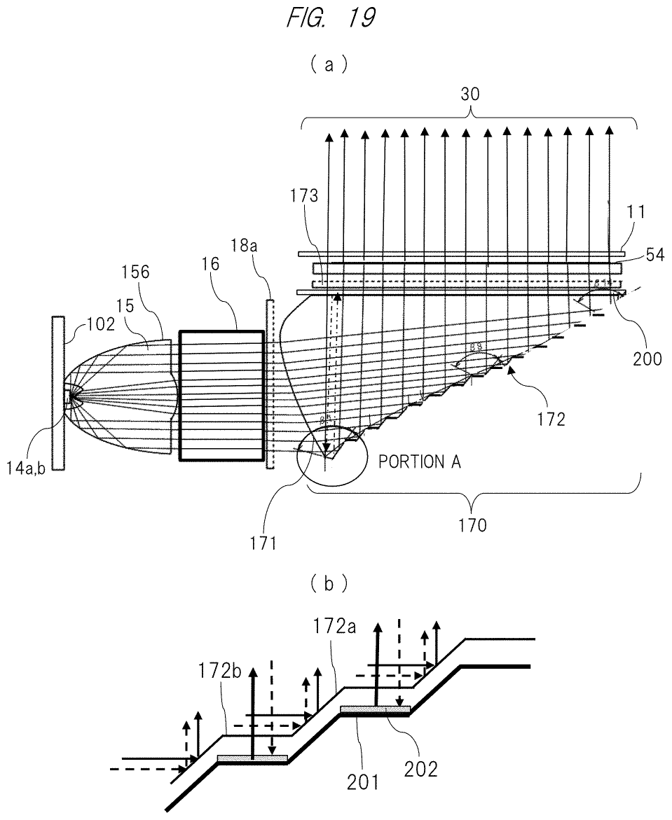

Another example of the configuration of the optical system of the light source apparatus 13 or others is shown in FIG. 19. Also in the optical system shown in FIG. 19, as similar to the example shown in FIG. 18, a plurality of (in this example, two) LEDs 14a and 14b configuring the light source are illustrated and attached at predetermined positions to correspond to the collimator 15. Note that each collimator 15 is made of, for example, a light-transmittable resin such as acrylic resin. As similar to the example shown in FIG. 18, the collimator 15 has a conically convex outer circumferential surface 156 formed by rotation of a paraboloid cross section, and has a concave portion 153 with a convex center (in other words, a convex lens surface) 157 at its apex. Note that the paraboloid surface 156 forming the conically-shaped outer circumferential surface is set within a range of an angle allowing the light peripherally emitted from the LED element 14a to be totally reflected inside, or forms the reflection surface.

The LEDs 14a and 14b are arranged at predetermined positions, respectively, on the surface of the LED board 102 that is its circuit board. The LED board 102 is arranged and fixed so that each of the LED elements 14a and 14b on the surface is positioned at center of the concave portion 153 to correspond to the collimator 15.

In such a configuration, among the light emitted from the LED element 14a or 14b, particularly the light emitted upward (in the right direction in the drawing) from its center is collected by the two convex lens surfaces 157 and 154 forming the outer shape of the collimator 15 to form the substantially collimated light. The light peripherally emitted from other portions is reflected by the paraboloid surface forming the conically-shaped outer circumferential surface of the collimator 15, and is similarly collected to form the substantially collimated light. In other words, by the collimator 15 having the convex lens formed on its center and the paraboloid surface formed on the peripheral portion, almost all the light components generated by the LED 14 or 14b can be extracted as the collimated light, and the use efficiency of the generated light can be improved.

Note that a light emission region of the collimator 15 is provided with the light guiding body 170 to interpose the first diffuse plate 18a therebetween. The light guiding body 170 is a member made of a light transmittable resin such as acrylic resin and shaped in a bar having a substantially triangle cross section (see FIG. 19(a)), and has, as clearly seen from FIG. 19(a), a light entering portion (surface) 171 of the light-guiding-body 170 facing an emission surface of the diffuse block 16 to interpose the first diffuse plate 18a therebetween, a light-guiding-body light reflecting portion (surface) 172 forming a tilt surface, and a light-guiding-body light emission portion (surface) 173 facing the liquid crystal display panel 11 that is the liquid crystal display component to interpose a reflection-type light polarizer 200.

For example, if a member having a property that reflects the P-polarized light (but transmits the S-polarized light) is selected as the reflection-type light polarizer 200, the P-polarized light of the natural light emitted from the LED that is the light source is converted to the S-polarized light when being reflected, being transmitted through the λ/4 waveplate 202 arranged on the light-guiding-body light reflecting portion 172 shown in FIG. 19(b), being reflected by the reflecting surface 201, and being transmitted through the λ/4 waveplate 202 again, and all the luminous fluxes entering the liquid crystal display panel 11 are equalized to the S-polarized light.

Similarly, if a member having a property that reflects the S-polarized light (but transmits the P-polarized light) is selected as the reflection-type light polarizer 200, the S-polarized light of the natural light emitted from the LED that is the light source is converted to the P-polarized light when being reflected, being transmitted through the λ/4 waveplate 202 arranged on the light-guiding-body light reflecting portion 172 shown in FIG. 19(b), being reflected by the reflecting surface 201, and being transmitted through the λ/4 waveplate 202 again, and all the luminous fluxes entering a liquid crystal display panel 52 are equalized to the P-polarized light. Even by the above-described configuration, the light-polarization conversion is achieved.

<Third Example of Image Display Apparatus>

Subsequently, still another example (a third example of the image display apparatus) of the specific configuration of the image display apparatus 1 will be explained with reference to FIG. 16. In a light source apparatus of this image display apparatus 1, the diffuse luminous flux of light (that is mixture of the P-polarized light and the S-polarized light) emitted from the LED is converted to the substantially collimated light by a collimator 18, and is reflected toward the liquid crystal display panel 11 by a reflecting surface of the reflection-type light guiding body 304. The reflection light enters the reflection-type light polarizer 49 arranged between the liquid crystal display panel 11 and the reflection-type light guiding body 304.

The specific polarized wave (such as the P-polarized light) is transmitted through the reflection-type light polarizer 49, and enters the liquid crystal display panel 11. Other polarized wave (such as the S-polarized light) is reflected by the reflection-type light polarizer 49, and propagates toward the reflection-type light guiding body 304 again. The reflection-type light polarizer 49 is tilted not to be perpendicular to principal ray of the light emitted from the reflecting surface of the reflection-type light guiding body 304, and the principal ray having been reflected by the reflection-type light polarizer 49 enters a transmission surface of the reflection-type light guiding body 304.

The light having entered the transmission surface of the reflection-type light guiding body 304 is transmitted through a back surface of the reflection-type light guiding body 304, is transmitted through a λ/4 waveplate 270 that is a phaser difference plate (retarder), and is reflected by a reflecting plate 271. The light having been reflected by the reflecting plate 271 is transmitted through the λ/4 waveplate 270 again, and is transmitted through the transmission surface of the reflection-type light guiding body 304. The light having been transmitted through the transmission surface of the reflection-type light guiding body 304 enters the reflection-type light polarizer 49 again.

In this case, the light having entered the reflection-type light polarizer 49 again is converted in terms of the light polarization to the polarized wave (such as the P-polarized light) being transmitted through the reflection-type light polarizer 49 because of being transmitted through the λ/4 waveplate 270 twice. Therefore, the light having been converted in terms of the light polarization is transmitted through the reflection-type light polarizer 49, and enters the liquid crystal display panel 11. Regarding design of the light polarization in the light-polarization conversion, note that the polarized wave may be inversely configured (the P-polarized light and the S-polarized light may be switched) in the above-described explanation.

As a result, the light emitted from the LED is equalized to have the specific polarized wave (such as the P-polarized light), enters the liquid crystal display panel 11, is modulated in terms of luminance in accordance with the image signal, and is displayed as an image on the panel surface. As similar to the above-described example, a plurality of LEDs configuring the light source are arranged (however, only one LED is illustrated in FIG. 16 because the drawing is a vertical cross-sectional view), and these LEDs are attached at predetermined positions to correspond to the collimator 18.

Note that each collimator 18 is made of, for example, a light-transmittable resin such as acrylic resin or glass. The collimator 18 may have, for example, a conically convex outer circumferential surface formed by rotation of a paraboloid cross section. And, its apex may have a concave portion with a convex center (in other words, a convex lens surface). And, center of its plane portion has a convex lens surface that protrudes outward (or may be a concave lens surface that is recessed inward). Note that the outer shape of the light receiver of the light guiding body to which the LED element 201 is attached is the paraboloid shape forming the conically-shaped outer circumferential surface, and is set within a range of an angle allowing the light peripherally emitted from the LED element to be totally reflected inside, or forms the reflection surface.

Note that the LED is arranged at each of predetermined positions on the surface of the LED board 102 that is its circuit board. The LED board 102 is arranged and fixed so that each LED on the surface is positioned at center of the conical convex apex to correspond to the collimator 18.

In such a configuration, among the light emitted from the LED, particularly the light emitted from its center is collected by the convex lens surface forming the outer shape of the collimator 18 to form the collimated light. The light peripherally emitted from other portions is reflected by the paraboloid surface forming the conically-shaped outer circumferential surface of the collimator 18, and is similarly collected to form the collimated light. In other words, by the collimator 18 having the convex lens formed on its center and the paraboloid surface formed on the peripheral portion, almost all the light components generated by the LED can be extracted as the collimated light, and the use efficiency of the generated light can be improved.

The above-described configuration is the same configuration as that of the light source apparatus of the image display apparatus shown in FIGS. 17 and 18 and others. Further, the light having been converted to the substantially collimated light by the collimator 18 shown in FIG. 16 is reflected by the reflection-type light guiding body 304. The specific polarized light of this light is transmitted through the reflection-type light polarizer 49 by the function of the reflection-type light polarizer 49, and other polarized light having been reflected by the function of the reflection-type light polarizer 49 is transmitted through the light guiding body 304 again. This light is reflected by a reflecting plate 271 at a position opposite to that of the liquid crystal display panel 11 across the reflection-type light guiding body 304. In this case, this light is converted in terms of light polarization when being transmitted through the λ/4 plate 270 that is the waveplate twice.

The light having been reflected by the reflecting plate 271 is transmitted through the reflection-type light guiding body 304 again, and enters the reflection-type light polarizer 49 arranged on the opposite surface. The incident light is transmitted through the reflection-type light polarizer 49 because of having been converted in terms of light polarization, and is equalized in terms of the light polarization direction, and enters the liquid crystal display panel 11. As a result, all the light components of the light source can be used, and the geometric optic use efficiency of the light is doubled. And, a polarization degree (extinction ratio) of the reflection-type light polarizer is also included in an extinction ratio of the entire system. Therefore, when the light source apparatus of the present embodiment is used, the contrast ratio of the entire display apparatus can be significantly improved.

By adjustment of surface roughness of the reflecting surface of the reflection-type light guiding body 304 and surface roughness of the reflecting plate 271, a light-reflection diffuse angle on each reflecting surface can be adjusted. In order to achieve more preferable equalization of the light entering the liquid crystal display panel 11, the surface roughness of the reflecting surface of the reflection-type light guiding body 304 and the surface roughness of the reflecting plate 271 may be adjusted for each design.

In the example explained in FIG. 16, note that the λ/4 plate 270 that is the waveplate is configured so that the phase difference with respect to the polarized light vertically entering the λ/4 plate 270 is λ/4. However, such a configuration is not always necessary. In the configuration in FIG. 16, the λ/4 plate 270 is only necessary to be a waveplate by which the phase of the polarized light changes by 90° (λ/2) when being transmitted twice. A thickness of the waveplate may be adjusted in accordance with distribution of the incident angle of the polarized light.

<Fourth Example of Image Display Apparatus>

Further, still another example (a fourth example of the image display apparatus) of the configuration of the optical system such as the light source apparatus of the image display apparatus will be explained with reference to FIG. 25. FIG. 25 shows a configuration example in a case of use of a diffuse sheet in place of the reflection-type light guiding body 304 in the light source apparatus of the image display apparatus.

Specifically, two optical sheets (an optical sheet 207A and an optical sheet 207B) that convert the diffuse properties in the vertical direction and the horizontal direction (the not-illustrated front and back direction in the drawing) in the drawing are used for the light emission region of the collimator 18, and the light emitted from the collimator 18 is caused to enter a gap between the two optical sheets (diffuse sheets). The number of the optical sheets may be configured to be not two but one. When the optical sheet is made of one sheet, the diffuse properties in the vertical direction and the horizontal direction are adjusted by fine shapes of a front surface and a back surface of the one optical sheet.

Alternatively, a plurality of diffuse sheets may be used so that the diffuse sheets play roles of the diffuse functions, respectively. In this case, in the example of FIG. 25, regarding the reflection diffuse property based on the front surface shape and the back surface shape of the optical sheet 207A and the optical sheet 207B, the number of LEDs, the divergence angle from the LED board (optical element) 102 and the optical specification of the collimator 18 may be optimally designed as design parameters so that the surface density of the luminous flux emitted from the liquid crystal display panel 11 is equalized. In other words, the diffuse properties are adjusted by the surface shapes of the plurality of diffuse sheets in place of the light guiding body.

In the example shown in FIG. 25, the light polarization is converted by the same method as that of the third example of the display apparatus. In other words, in the example shown in FIG. 25, the reflection-type light polarizer 49 may be configured to have the property reflecting the S-polarized wave (but transmitting the P-polarized wave). In this case, the P-polarized wave of the light emitted from the LED that is the light source is transmitted, and the transmitted light enters the liquid crystal display panel 11. The S-polarized wave of the light emitted from the LED that is the light source is reflected, and the reflected light is transmitted through the waveplate 270 shown in FIG. 25.

Then, the light having been transmitted through the waveplate 270 is reflected by the reflecting plate 271. The light having been reflected by the reflecting plate 271 is converted to the P-polarized wave when being transmitted through the waveplate 270 again. The light having been converted in terms of the light polarization is transmitted through the reflection-type light polarizer 49, and enters the liquid crystal display panel 11. Note that the λ/4 plate 270 that is the waveplate of FIG. 25 is not always configured so that the phase difference with respect to the polarized light vertically entering the λ/4 plate 270 is λ/4. In the configuration in FIG. 25, the λ/4 plate 270 is only necessary to be a waveplate by which the phase of the polarized light changes by 90° (λ/2) when being transmitted twice. A thickness of the waveplate may be adjusted in accordance with distribution of the incident angle of the polarized light. Even in FIG. 25, regarding design of the light polarization in the light-polarization conversion, note that the polarized wave may be inversely configured (the P-polarized light and the S-polarized light may be switched) in the above-described explanation.

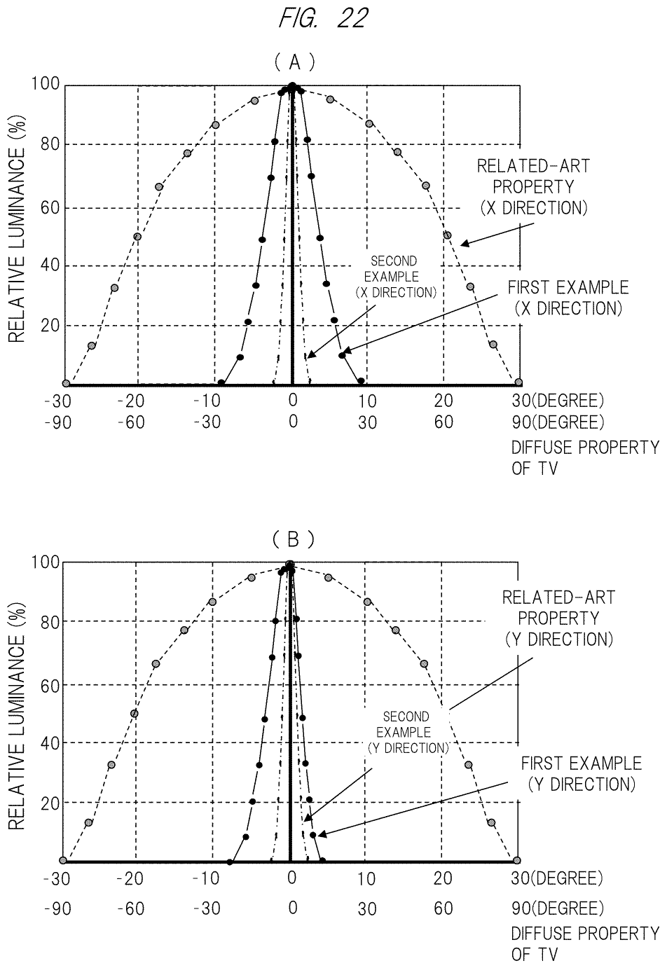

In a general apparatus for TV, for example, as shown in a plot curve of “related-art property (X direction)” in FIG. 22(A) and “related-art property (Y direction)” in FIG. 22(B), the light emitted from the liquid crystal display panel 11 has a diffuse property that is the same between a screen horizontal direction (that is a display direction corresponding to an X axis of the graph of FIG. 22(A)) and a screen vertical direction (that is a display direction corresponding to a Y axis of the graph of FIG. 22(B)).

On the other hand, the diffuse property of the luminous flux emitted from the liquid crystal display panel of the present example is as shown in, for example, the plot curve of the “first example (X direction)” in FIG. 22(A) and the “first example (Y direction)” in FIG. 22(B).

In one specific example, when a viewing angle having a luminance that is 50% (luminance decreasing to about half) of a luminance of front view (angle of 0 degree) is set to 13 degrees, this is about ⅕ of a diffuse property (angle of 62 degrees) of the general apparatus for household use TV. Similarly, in a case in which upper and lower viewing angles in the vertical direction are set to be unequal, a reflection angle of the reflection-type light guiding body, an area of the reflection surface and others are optimized so that the upper viewing angle is suppressed (narrowed) to be about ⅓ of the lower viewing angle.

By the setting of the viewing angles or others as described above, light quantity of the image that propagates toward the viewing direction of the user is significantly increased more (significantly improved more in terms of brightness of the image) than that of a related-art liquid crystal TV, and the luminance of this image is equal to or higher than 50 times.

Further, in the case of the viewing-angle property described in the “second example” of FIG. 22, when the viewing angle having the luminance of 50% (luminance decreasing to about half) of the luminance of the image provided in the front view (angle of 0 degree) is set to 5 degrees, this is an angle that is about 1/12 (narrow viewing angle) of the diffuse property (angle of 62 degrees) of the general apparatus for household use TV. Similarly, in a case in which the upper and the lower viewing angles in the vertical direction are set to be equal, the reflection angle of the reflection-type light guiding body, the area of the reflection surface and others are optimized so that the viewing angle in the vertical direction is suppressed (narrowed) to about 1/12 of the related art.

By the setting as described above, the luminance (light quantity) of the image that propagates toward the viewing direction (a line-of-sight direction of the user) is significantly improved more than that of the related-art liquid crystal TV, and the luminance of this image is equal to or higher than 100 times.

When the viewing angle is set to the narrow angle as described above, the luminous flux quantity that propagates toward the viewing direction can be concentrated, and therefore, the light use efficiency is significantly improved. As a result, even in the use of the general liquid crystal display panel for TV, the significant improvement of the luminance can be achieved at the similar power consumption by the adjustment of the light diffuse property of the light source apparatus, and an image display apparatus handling an information display system for bright outside can be achieved.

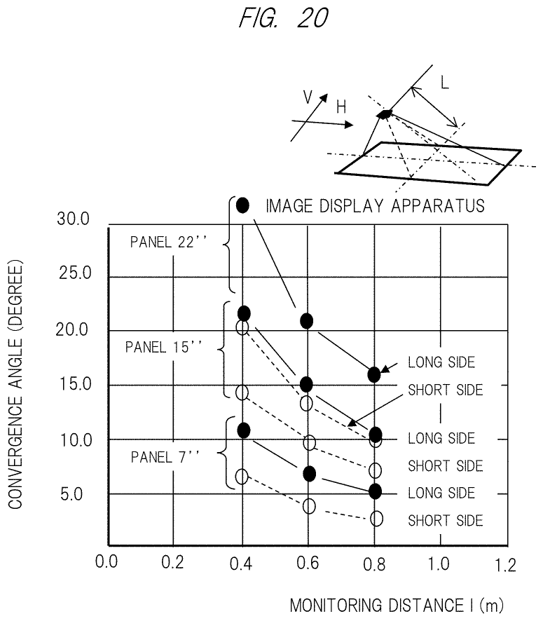

In use of a large liquid crystal display panel, when the light on the periphery of the screen is directed inward to propagate toward the viewing person when the viewing person faces the center of the screen, a full-screen performance in terms of the screen brightness is improved. In FIG. 20, a convergence angle made by a long side of the liquid crystal display panel and a short side of the liquid crystal display panel is made by using a distance “L” from the liquid crystal display panel to the viewing person and a panel size (screen ratio (16:10)) of the image display apparatus as parameters.

An upper drawing of FIG. 20 is in assumption that the image is viewed so that the screen of the liquid crystal display panel is portrait-oriented (also referred to as “vertically-long use” below). In this case, the convergence angle may be set to match with the short side of the liquid crystal display panel (see a direction of an arrow “V” in FIG. 20 as necessary). In more specific example, with reference to the plot graph in FIG. 20, for example, in the viewing case of the vertically-long use of the 22″ panel is 0.8 m, when the convergent angle is set to 10 degrees, the image light emitted from each of (four) corners of the screen can be effectively projected or output to the viewing person.

Similarly, in the viewing case of the vertically-long use of the 15″ panel is 0.8 m, when the convergent angle is set to 7 degrees, the image light emitted from the four corners of the screen can be effectively caused to propagate toward the viewing person. As described above, depending on the size of the liquid crystal display panel or whether the use is the vertically-long use or the horizontally-long use, the image light on the periphery of the screen is caused to propagate toward the viewing person at the optimal position for viewing the center of the screen, and, as a result, the full-screen performance in terms of the screen brightness can be improved.

In a basic configuration, when the luminous flux having the narrow-angle directionality is caused to enter the liquid crystal display panel 11 by the light source apparatus as shown in FIG. 16 described above and others and is modulated in terms of the luminance in accordance with the image signal, the image information displayed on the screen of the liquid crystal display panel 11 is reflected by the retroreflector, and the resultant aerial floating image is displayed inside or outside the room through the transparent member 100.

A plurality of examples will be explained below as another example of the light source apparatus. All such another examples of the light source apparatus are applicable in place of the light source apparatus of the above-described example of the image display apparatus.

### First Another Example of Light Source Apparatus

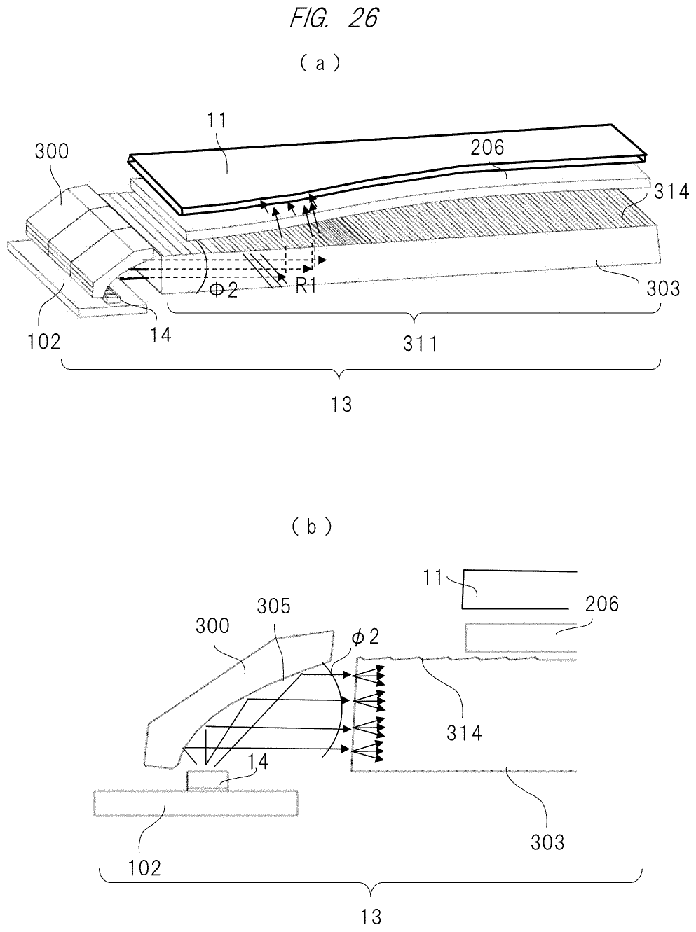

With reference to FIGS. 26(a) and 26(b), another example of the light source apparatus will be explained. FIG. 26(a) is a diagram in which a part of the diffuse plate 206 and the liquid crystal display panel 11 are eliminated for explaining the light guiding body 311.

FIG. 26 shows a state of the board 102 provided with the LED 14 configuring the light source. The LED 14 and the board 102 are attached at predetermined positions to correspond to a reflector 300.

As shown in FIG. 26(a), the LEDs 14 are arranged on a line in parallel to the side (in this example, the short side) of the liquid crystal display panel 11 to be close to the arrangement of the reflector 300. In the illustrated example, the reflector 300 is arranged to correspond to the arrangement of the LED. Note that a plurality of the reflectors 300 may be arranged.

In a specific example, each reflector 300 is made of a plastic material. As another example, the reflector 300 may be made of a metal material or a glass material. However, since the plastic material is easier to be shaped, the plastic material is used in the present example.

As shown in FIG. 26(b), an inner (in the drawing, right) surface of the reflector 300 has a reflection surface (referred to as “paraboloid surface” below) 305 having a shape resulted from cut of a paraboloid surface at a meridional plane. In the reflector 300, the diverging light emitted from the LED 14 is converted to the substantially collimated light by being reflected by the reflection surface 305 (paraboloid surface), and the converted light is caused to enter an end surface of the light guiding body 311. In a specific example, the light guiding body 311 is a transmission-type light guiding body.

The reflection surface of the reflector 300 has a shape that is asymmetric across an optical axis of the light emitted from the LED 14. Since the reflection surface 305 of the reflector 300 is the paraboloid surface as described above, the reflected luminous flux is converted to the substantially collimated light when the LED is arranged at a focal point of this paraboloid surface.

The diverging light emitted from the LED cannot be converted to the completely collimated light even when the LED 14 is arranged at the focal point of this paraboloid surface because the LED 14 is the surface light source. However, a performance of the light source of the present invention is not affected. The LED 14 and the reflector 300 is a pair, and the number of the attachment of the LEDs on the board should be equal to or smaller than 10 in order to secure a predetermined performance when accuracy of the attachment of the LEDs on the board is ±40 μm, and is better to be about 5 in consideration of mass productivity.

The LED 14 and the reflector 300 are partially close to each other, and rise of a temperature of the LED can be reduced since the heat can be released to a space near an opening of the reflector 300. Therefore, the plastic-molded reflector 300 is applicable. As a result, the shaping accuracy of the reflection surface can be improved to be equal to or higher than 10 times of that of the glass reflector, and therefore, the light use efficiency can be improved.

Meanwhile, a base surface 303 of the light guiding body 311 is provided with a reflection surface, and the light emitted from the LED 14 is converted to the collimated light by the reflector 300, and then, is reflected by this reflection surface, and is emitted toward the liquid crystal display panel 11 facing the light guiding body 311. The reflection surface formed on the base surface 303 may have a plurality of surfaces that are different from one another in a tilt in the propagation direction of the collimated luminous flux emitted from the reflector 300 as shown in FIG. 26. Each surface of the plurality of surfaces that are different from one another in the tilt may have a shape extending in a direction perpendicular to the propagation direction of the collimated luminous flux emitted from the reflector 300.

A shape of the reflection surface formed on the base surface 303 may be a flat shape. In this case, by a refraction surface 314 formed on a surface of the light guiding body 311 facing the liquid crystal display panel 11, the light having been reflected on the reflection surface formed on the base surface 303 of the light guiding body 311 is refracted, and the light quantity and the emission direction of the luminous flux that propagates toward the liquid crystal display panel 11 are accurately adjusted.

The refraction surface 314 may include a plurality of surfaces that are different from one another in a tilt in the propagation direction of the collimated luminous flux emitted from the reflector 300 as shown in FIG. 26. Each surface of the plurality of surfaces that are different from one another in the tilt may have a shape extending in a direction perpendicular to the propagation direction of the collimated luminous flux emitted from the reflector 300. By the tilt of each of the plurality of surfaces, the light having been reflected by the reflection surface formed on the base surface 303 of the light guiding body 311 is refracted toward the liquid crystal display panel 11. Alternatively, the refraction surface 314 may be a light transmittable surface.

If the diffuse plate 206 is placed in front of the liquid crystal display panel 11, note that the light having been reflected by the reflection surface is refracted toward the diffuse plate 206 by the plurality of tilts of the refraction surface 314. In other words, an extending direction of each of the plurality of surfaces different from one another in the tilt on the refraction surface 314 and an extending direction of each of the plurality of surfaces different from one another in the tilt on the reflection surface formed on the base surface 303 are parallel. Since the both extending directions are made parallel, the angle of the light can be more preferably adjusted. Meanwhile, the LED 14 is soldered on a metallic board 102. Therefore, the heat generated in the LED can be released to air through the board.

The reflector 300 may be in contact with the board 102 or be spaced from it. When the space is formed, the reflector 300 is arranged to be tightly close to a housing. By the formed space, the heat generated in the LED can be released to air, and the cooling effect is enhanced. As a result, an operation temperature of the LED can be lowered, and therefore, retention of the light emission efficiency and the long life can be achieved.

<Second Another Example of Light Source Apparatus>

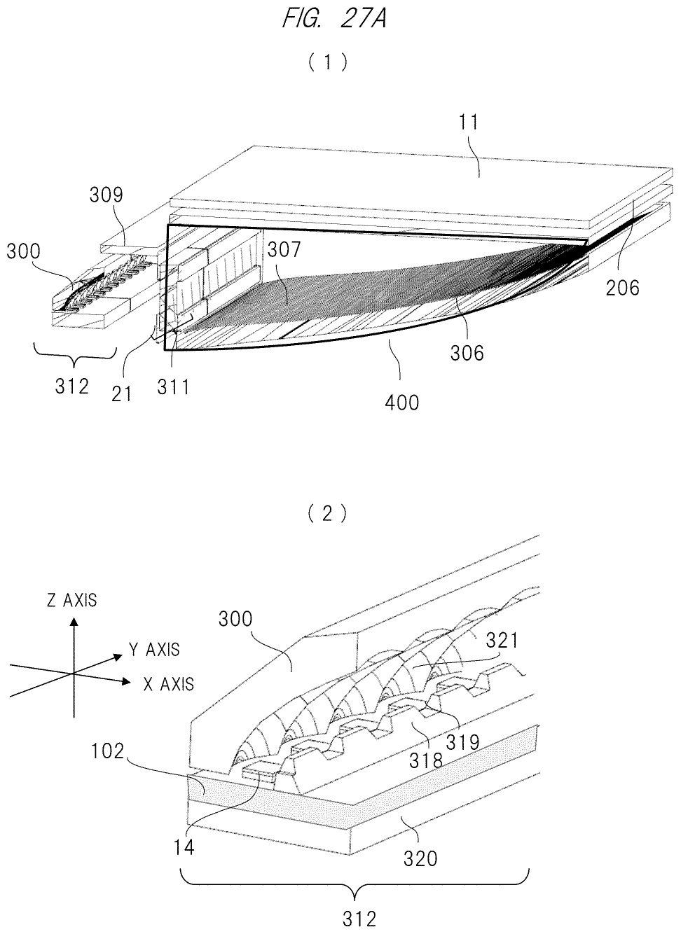

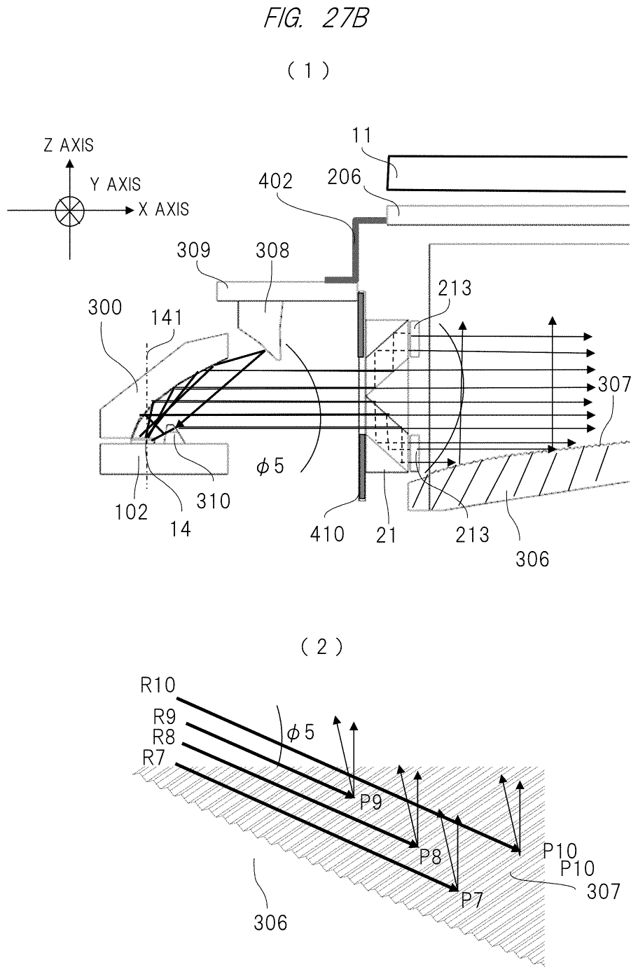

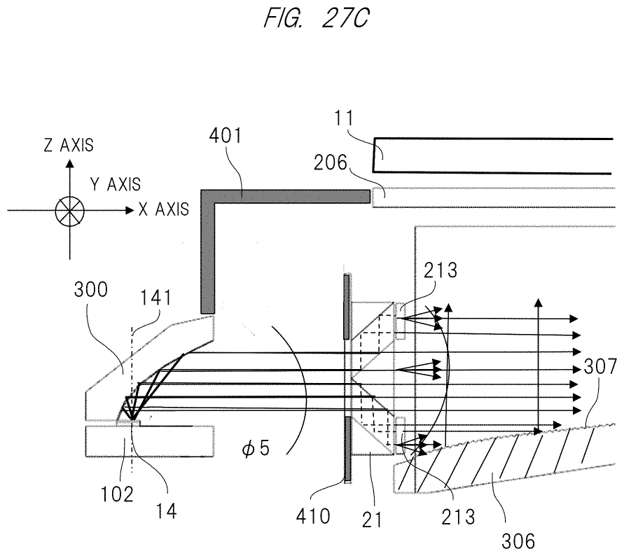

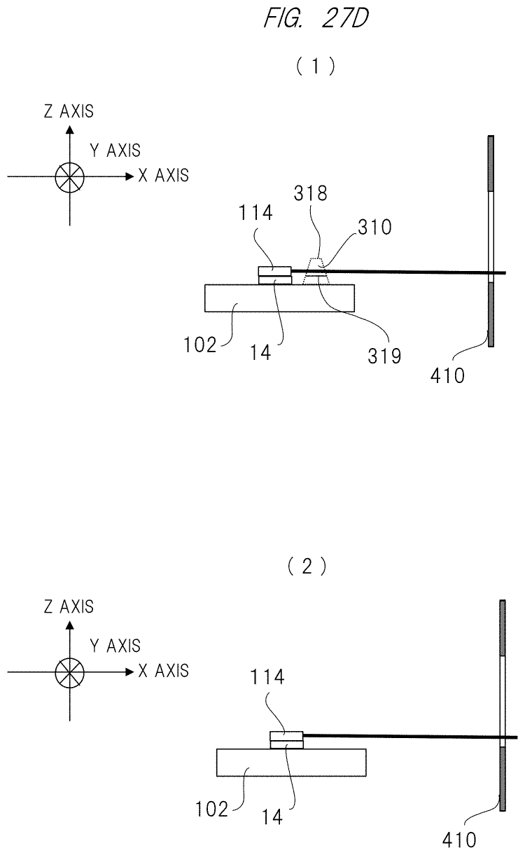

Subsequently, a configuration of an optical system regarding a light source apparatus having a light use efficiency that is 1.8 times better than that of the light source apparatus shown in FIG. 26 under the usage of the light-polarization conversion will be explained in detail with reference to FIGS. 27A (1) and (2), 27B (1) and (2), 27C and 27D (1) and (2). In FIG. 27A (1), note that illustration of a sub reflector 308 is omitted.

FIGS. 27A, 27B and 27C illustrate the state of the board 102 provided with the LED 14 configuring the light source, and a unit 312 is configured to include a plurality of blocks each made of a pair of the reflector 300 and the LED 14.

Among these members, a base member 320 shown in FIG. 27A (2) is a base member of the board 102. Generally, the metallic board 102 has heat, and therefore, the base member 320 may be made of a plastic material or others in order to (thermally) insulate the heat of this board 102. A material and a shape of the reflection surface of the reflector 300 may be the same material and shape as those of the example of the light source apparatus of FIG. 26.

The reflection surface of the reflector 300 may have a shape that is asymmetric across the optical axis of the light emitted from the LED 14. A reason for this will be explained with reference to FIG. 27A (2). In the present example, the reflection surface of the reflector 300 is the paraboloid surface as similar to that of the example of FIG. 26, and the center of the light emission surface of the LED that is the surface light source is arranged at the focal position of the paraboloid surface.

And, because of the characteristics of the paraboloid surface, the light emitted from the four corners of the light emission surface also becomes the substantially collimated luminous flux, and only has the different light emission direction. Therefore, even if the light emitting unit has an area, when a distance between the reflector 300 and the polarization converter element arranged at the subsequent stage is small, the light quantity and the conversion efficiency of the light entering the polarization converter element 21 are hardly affected.

And, even if the attachment position of the LED 14 shifts on an X-Y plane from the focal point of the corresponding reflector 300, the optical system capable of suppressing the reduction of the light conversion efficiency can be achieved because of the above-described reason. Further, even if the attachment position of the LED 14 varies in a Z-axis direction, only movement of the converted collimated luminous flux on a Z-X plane is caused, the accuracy of the attachment of the LED that is the surface light source can be significantly reduced. Also in the present example, the reflector 300 having the reflection surface resulted from cutting of a part of the paraboloid surface on a meridian has been explained. However, the LED may be arranged in a cut part of the entire paraboloid surface as the reflection surface.

On the other hand, as shown in FIGS. 27B (1) and 27C, the present example has a characteristic configuration in which the diffuse light emitted from the LED 14 is reflected and converted to the substantially collimated light by the paraboloid surface 321, and then, is caused to enter the end surface of the polarization converter element 21 at the subsequent stage, and is equalized to have the specific polarized wave by the polarization converter element 21. By such a characteristic configuration, the light use efficiency of the present invention is 1.8 times better than that of the example of FIG. 26, and the light source having high efficiency can be achieved.

In this case, note that all components of the substantially collimated light resulted from the reflection of the diffuse light emitted from the LED 14 by the paraboloid surface 321 are not equalized. Therefore, the angular distribution of the reflection light is adjusted by the reflection surface 307 having the plurality of tilts, and the light can be caused to enter the liquid crystal display panel 11 in the vertical direction to the liquid crystal display panel 11.

In the example of these drawings, the direction of the light (principal ray) entering the reflector from the LED and the direction of the light entering the liquid crystal display panel are arranged to be substantially parallel to each other. This arrangement is easily made in terms of the design, and arrangement of the thermal source below the light source apparatus is more preferable since the temperature increase of the LED can be decreased by the upward air release.

As shown in FIG. 27B (1), in order to improve a capture rate of the diffuse light emitted from the LED 14, the luminous flux incapable of being captured by the reflector 300 is reflected by the sub reflector 308 formed in a light shielding plate 309 above the reflector, is reflected by a tilt surface of a sub reflector 310 on a lower side, is caused to enter an effective region of the polarization converter element 21 at the subsequent stage, and the light use efficiency is further improved. In other words, in the present example, a part of the light having been reflected by the reflector 300 is reflected by the sub reflector 308, and the light having been reflected by the sub reflector 308 is reflected toward the light guiding body 306 by the reflector 310.

Accordingly, the substantially collimated luminous flux having the specific polarized wave equalized by the polarization converter element 21 is reflected by the reflection shape on the surface of the reflection-type light guiding body 306 toward the liquid crystal display panel 11 facing the light emission surface of the reflection-type light guiding body 306. In this case, the light-quantity distribution of the luminous flux entering the liquid crystal display panel 11 is determined by the previous setting or adjustment (optimal design) of the shape and the arrangement of the reflector 300, and the reflection surface shape (cross-sectional shape), the reflection surface tilt and the surface roughness of the reflection-type light guiding body and others. In other words, by the optimization of the setting or adjustment items, the light-quantity distribution of the luminous flux entering the liquid crystal display panel 11 is optimized.

The plurality of reflection surfaces are arranged as the reflection surface shape formed on the surface of the light guiding body 306 to face the light emission surface of the polarization converter element, and the tilt of the reflection surface, the area, the height and the pitch are optimized in accordance with the distance from the polarization converter element 21, and, as a result, the light-quantity distribution of the luminous flux entering the liquid crystal display panel 11 is set to be a desirable value as described above.

The reflection light can be accurately adjusted when the reflection surface 307 formed on the reflection-type light guiding body is configured to have one surface with the plurality of tilts as shown in FIG. 27B (2). In such a configuration of the reflection surface having one surface with the plurality of tilts, note that a region to be used as the reflection surface may be made of a plurality of surfaces, a polygonal surface or a curved surface. Further, the light-quantity distribution can be more equalized by a diffuse function of the diffuse plate 206. The light-quantity distribution of the light entering the diffuse plate closer to the LED can be equalized by change of the tilt of the reflection surface.

In the present example, a plastic material such as heat-resistant polycarbonate is used for the base member of the reflection surface 307. An angle of the reflection surface 307 to which the light propagates immediately after the light emission from the λ/2 plate 213 is changed in accordance with a distance between the λ/2 plate and the reflection surface.

Also in the present example, the LED 14 and the reflector 300 are partially close to each other, the heat can be released to the space near the opening of the reflector 300, and the temperature increase of the LED can be decreased. Alternatively, vertical arrangement order of the board 102 and the reflector 300 may be inversed from the arrangement of FIGS. 27A, 27B and 27C.

However, if the board 102 is arranged on the upper side, the board 102 is close to the liquid crystal display panel 11, and therefore, layout may be made difficult. Therefore, the arrangement of the board 102 below the reflector 300 (to be farther from the liquid crystal display panel 11) as shown in the drawing makes the configuration in the apparatus simpler.

The light entering surface of the polarization converter element 21 may be provided with a light shielding plate 410 in order to prevent the unnecessary light from entering the optical system at the subsequent stage. By such a configuration, the light source apparatus in which the temperature increase is suppressed can be achieved. The light polarizer on the light entering surface of the liquid crystal display panel 11 can absorb the luminous flux having the equalized light polarization to decrease the temperature increase, and the light polarizer on the entering side can absorb a part of the light having the light polarization direction rotated when being reflected by the reflection-type light guiding body. The temperature of the liquid crystal display panel 11 is also increased by the temperature increase due to the absorbance in the liquid crystals themselves and the light entering the electrode pattern. However, since there is the sufficient space between the liquid crystal display panel 11 and the reflection surface of the reflection-type light guiding body 306, the temperature increase of the liquid crystal display panel 11 can be suppressed by natural cooling using this space.

FIG. 27D shows a modification example of the light source apparatus of FIGS. 27B (1) and 27C. FIG. 27D (1) shows a modification example of the light source apparatus of FIG. 27B (1) while extracting a part of the same. Configurations of other components are the same as those of the light source apparatus of FIG. 27B (1), and therefore, illustration and repetitive explanation of the same will be omitted.

First, in the example shown in FIG. 27D (1), a height of a concave portion 319 of the sub reflector 310 is adjusted to be lower than a fluorescent body 114 so that principal ray of the fluorescence (see a straight line extending in a direction parallel to an X-axis in FIG. 27D (1)) emitted in a horizontal direction (X-axis direction) from the fluorescent body 114 is released out of the concave portion 319 of the sub reflector 310. Further, a height of a light shielding plate 410 in a Z-axis direction is adjusted to be lower than the position of the fluorescent body 114 so that the principal ray of the fluorescence emitted in the horizontal direction from the fluorescent body 114 is not shielded by the light shielding plate 410 and enters the effective region of the polarization converter element 21.

The reflection surface of the convex portion of convex and concave on the apex of the sub reflector 310 reflects the light having been reflected by the sub reflector 308 in order to guide the light having been reflected by the sub reflector 308 toward the light guiding body 306. Therefore, a height of a convex portion 318 of the sub reflector 308 is adjusted so that the light having been reflected by the sub reflector 308 is reflected and is caused to enter the effective region of the polarization converter element 21 at the subsequent stage, and, as a result, the light use efficiency can be further improved.

Note that the sub reflector 310 is arranged to extend in one direction as shown in FIG. 27A (2), and has the convex and concave shape. On the apex of the sub reflector 310, convex and concave having one or more concave portions are periodically arranged in one direction. Such a convex and concave shape achieves the configuration in which the principal ray of the fluorescence emitted in the horizontal direction from the fluorescent body 114 enters the effective region of the polarization converter element 21.

The convex and concave shape of the sub reflector 310 is periodically arranged at a pitch at which the concave portion 319 is positioned at the LED 14. In other words, each fluorescent body 114 is periodically arranged in one direction to correspond to the pitch of the arrangement of the concave portion of the convex and concave of the sub reflector 310. If the LED 14 includes the fluorescent body 114, note that the fluorescent body 114 may be interpreted as the light emitting portion of the light source.

FIG. 27D (2) shows a modification example of the light source apparatus of FIG. 27C while extracting a part of the same. Configurations of other components are the same as those of the light source apparatus of FIGS. 27C, and therefore, illustration and repetitive explanation of the same will be omitted. As shown in FIG. 27D (2), the sub reflector 310 may be eliminated. However, as similar to FIG. 27D (1), the height of the light shielding plate 410 in the Z-axis direction is adjusted to be lower than the position of the fluorescent body 114 so that the principal ray of the fluorescence emitted in the horizontal direction from the fluorescent body 114 is not shielded by the light shielding plate 410 and enters the effective region of the polarization converter element 21.

In the light source apparatuses of FIGS. 27A, 27B, 27C and 27D, note that a sidewall 400 may be formed as shown in FIG. 27A (1) in order to prevent dusts from entering the space between the liquid crystal display panel 11 and the reflection surface of the reflection-type light guiding body 306, prevent stray light toward outside of the light source apparatus and prevent stray light from entering from the outside of the light source apparatus. When the sidewall 400 is formed, the sidewall 400 is arranged to sandwich a space between the light guiding body 306 and the diffuse plate 206.

The light emission surface of the polarization converter element 21 that emits the light having been converted in terms of the light polarization by this polarization converter element 21 faces a space surrounded by the sidewall 400, the light guiding body 306, the diffuse plate 206 and the polarization converter element 21. A reflection surface having a reflection film or others is used as a surface of inner surfaces of the sidewall 400, the surface covering, from a side surface, a space in which the light is emitted from the light emission surface of the polarization converter element 21 (the space is a right space of the light emission surface of the polarization converter element 21 of FIG. 27B (1)). In other words, a surface of the sidewall 400 facing this space has a reflection region including the reflection film. Since this portion of the inner surfaces of the sidewall 400 is used as the reflection surface, the light having been reflected by this reflection surface can be reused as the light of the light source, and the luminance of the light source apparatus can be improved.

The surface of the inner surfaces of the sidewall 400, the surface covering the polarization converter element 21 from the side surface, is formed as a surface having a low light reflectance (such as a black surface without the reflection film or others). This is because the reflection light on the side surface of the polarization converter element 21 generates the light having the unexpected light polarization state to be a cause of the stray light. In other words, when the surface is formed as the surface having the low light reflectance, the generation of the stray light of the image and the light having the unexpected light polarization state can be prevented or suppressed. Alternatively, a part of the sidewall 400 may be configured to have an air-flow hole to improve the cooling effect.

Note that the configuration using the polarization converter element 21 is a prerequisite on the explanation for the light source apparatuses of FIGS. 27A, 27B, 27C and 27D. However, a configuration in which the polarization converter element 21 is eliminated from such a light source apparatus is also applicable. In this case, such a light source apparatus can be provided at a less inexpensive cost.

<Third Another Example of Light Source Apparatus>

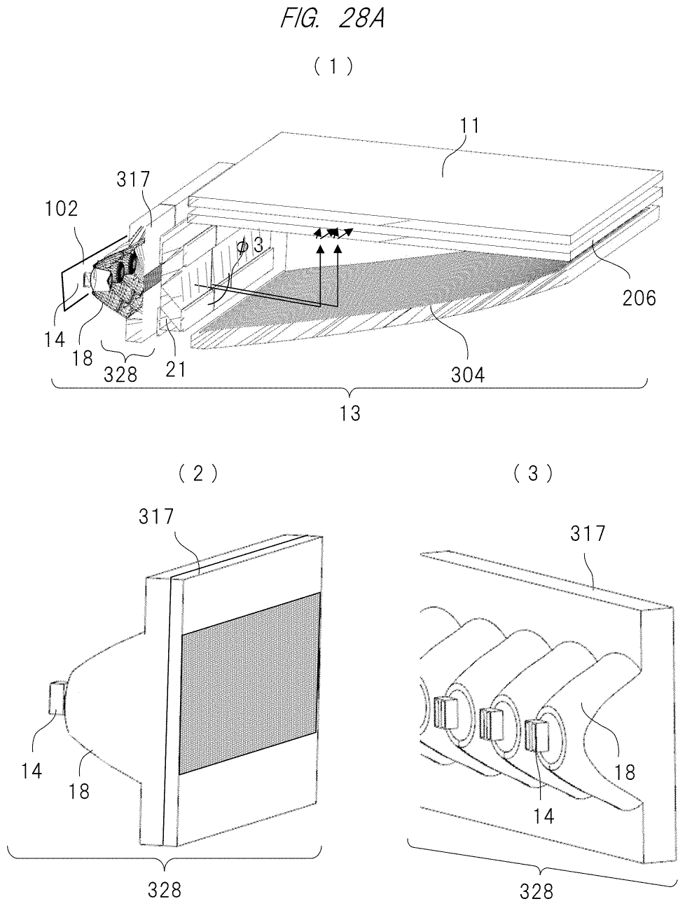

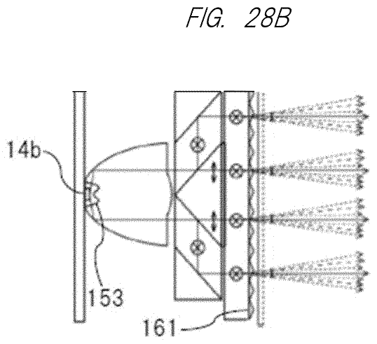

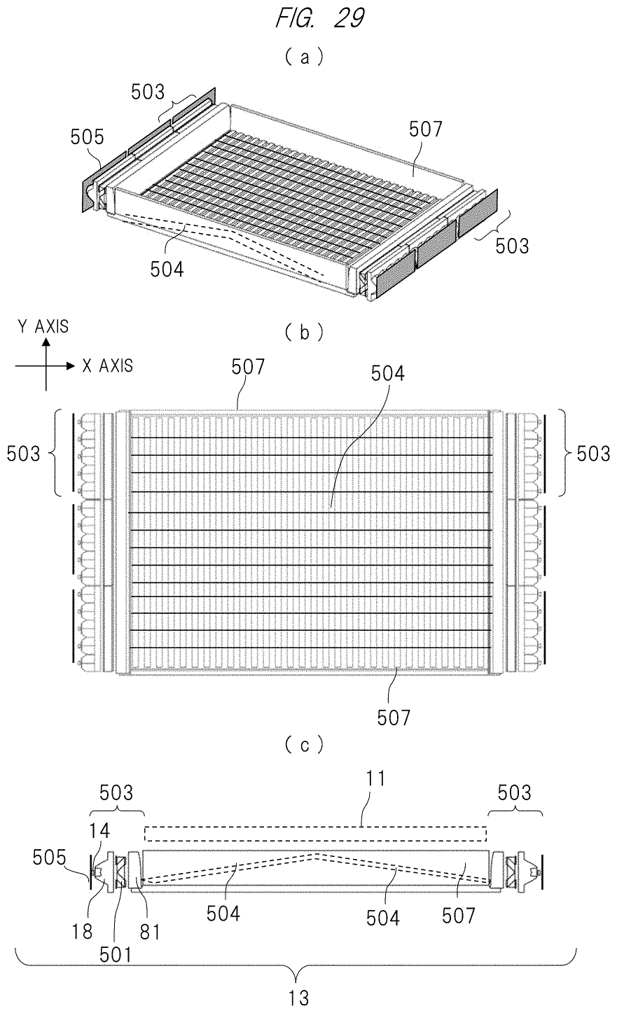

Subsequently, a configuration of an optical system regarding a light source apparatus using the reflection-type light guiding body 304 based on the light source apparatus shown in the first example of the light source apparatus will be explained in detail with reference to FIGS. 28A (1), (2) and (3) and 28B.

FIG. 28A shows a state of the board 102 provided with the LED 14 configuring the light source, and a unit 328 is configured to include a plurality of blocks each made of a pair of the collimator 18 and the LED 14. Since the collimator 18 of the present example is close to the LED 14, the glass material is used in consideration of the thermal resistance. A shape of the collimator 18 is the same as the shape explained in the collimator in FIG. 17. And, the light shielding plate 317 is arranged at a previous stage of the entering to the polarization converter element 21, and, as a result, the unnecessary light is prevented or suppressed from entering the optical system at a subsequent stage, and the temperature increase due to the unnecessary light is reduced.

Since other configurations and effects of the light source shown in FIG. 28A are the same as those of FIGS. 27A, 27B, 27C and 27D, the repetitive explanation thereof will be omitted. In the light source apparatus shown in FIG. 28A, a sidewall may be formed as similar to those explained in FIGS. 27A, 27B and 27C. A configuration and an effect of the sidewall has been already explained, and therefore, the repetitive explanation thereof will be omitted.

FIG. 28B is a cross-sectional view of FIG. 28A (2). A configuration of a light source shown in FIG. 28B is partially in common with the configuration of the light source shown in FIG. 18, and has been already explained in FIG. 18, and therefore, the repetitive explanation thereof will be omitted.

<Fourth Another Example of Light Source Apparatus>

Subsequently, in the light source apparatus of FIG. 29, a unit 328 is configured to include a plurality of blocks each made of a pair of the collimator 18 and the LED 14 used in the light source apparatus shown in FIG. 28. A configuration of an optical system regarding a light source apparatus using a reflection-type light guiding body 504 and an LED arranged on both ends of a back surface of the liquid crystal display panel 11 will be explained in detail with reference to FIGS. 29 (a), (b) and (c).

FIG. 29 shows a state of a board 505 provided with the LED 14 configuring the light source, and a unit 503 is configured to include a plurality of blocks each made of a pair of the collimator 18 and the LED 14. The unit 503 is arranged on both ends of the back surface of the liquid crystal display panel 11 (in the present example, three units are arranged to align in the short-side direction). The light emitted from the unit 503 is reflected by the reflection-type light guiding body 504, and is caused to enter the liquid crystal display panel 11 (illustrated in FIG. 29 (c)) facing thereto.

As shown in FIG. 29 (c), the reflection-type light guiding body 504 is separated into two blocks corresponding to the units arranged on the respective ends, and has a center portion formed to be the highest. Since the collimator 18 is close to the LED 14, the glass material is used in consideration of the thermal resistance against the heat generated in the LED 14. A shape of the collimator 18 is a shape as explained in the collimator 15 in FIG. 17.

The light emitted from the LED 14 enters a polarization converter element 501 through the collimator 18. In a configuration of this example, distribution of light entering the reflection-type light guiding body 504 at the subsequent stage is adjusted by a shape of an optical element 81. In other words, the light-quantity distribution of the luminous flux entering the liquid crystal display panel 11 is optimally designed by adjusting the shape and arrangement of the collimator 18, the shape and the diffuse property of the optical element 81, the shape (cross-sectional shape) of the reflection surface of the reflection-type light guiding body, the tilt of the reflection surface and the surface roughness of the reflection surface.

A plurality of reflection surfaces are arranged as the shape of the reflection surface formed on the surface of the reflection-type light guiding body 504 to face the light emission surface of the polarization converter element as shown in FIG. 29 (b), and the tilt of the reflection surface, the area, the height and the pitch are optimized in accordance with a distance from the polarization converter element 21. Also, a region to be the same reflection surface (the region is a surface facing the polarization converter element) is separated to form a polygon, and, as a result, the light-quantity distribution of the luminous flux entering the liquid crystal display panel 11 can be arranged to have a desirable (optimized) value as described above.

One surface (that is a light reflecting region) of the reflection surface formed on the reflection-type light guiding body is configured to have the shape with the plurality of tilts (in the example of FIG. 29, with 14-divided surfaces with different tilts on the X-Y plane), and, as a result, the reflection light can be more accurately adjusted. And, a light shielding wall 507 is arranged in order to prevent the reflection light emitted from the reflection-type light guiding body from leaking through a side surface of the light source apparatus 13, and, as a result, occurrence of leak light that does not propagate in the desirable direction (that is the direction toward the liquid crystal display panel 11) can be prevented.

The unit 503 arranged on right and left of the reflection-type light guiding body 504 of FIG. 29 may be replaced with the light source apparatus of FIG. 27. In other words, a plurality of the light source apparatuses (the board 102, the reflector 300, the LED 14 and others) of FIG. 27 may be prepared, and the plurality of the light source apparatuses may be arranged at positions facing one another with reference to FIGS. 29 (a), (b) and (c).

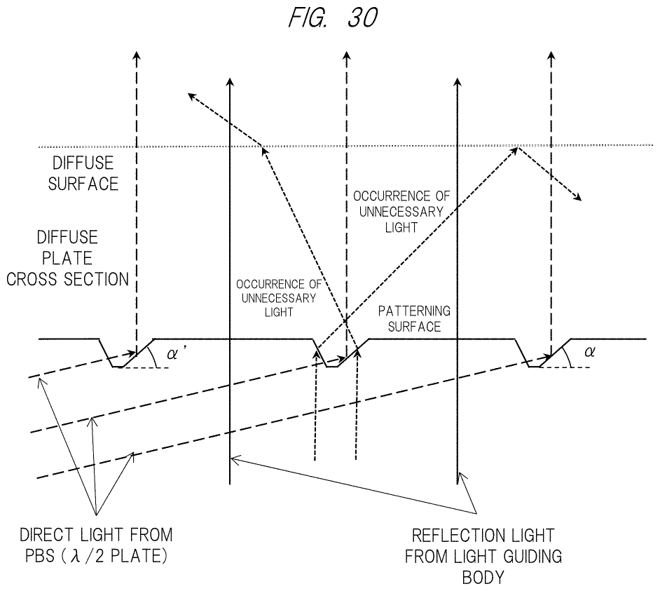

FIG. 30 is a cross-sectional view showing one example of a shape of the diffuse plate 206. As described above, the diffuse light emitted from the LED is converted to the substantially collimated light by the reflector 300 or the collimator 18, and is converted to have the specific polarized wave by the polarization converter element 21, and then, is reflected by the light guiding body. Then, the luminous flux having been reflected by the light guiding body is transmitted through a plane portion of a light entering surface of the diffuse plate 206, and enters the liquid crystal display panel 11 (see two solid-line arrows indicating “the reflection light emitted from the light guiding body” in FIG. 30).

The diffuse luminous flux of the light having been emitted from the polarization converter element 21 is totally reflected by a tilt surface of a protrusion having an oblique surface formed on the light entering surface of the diffuse plate 206, and enters the liquid crystal display panel 11. For the total reflection of the light having been emitted from the polarization converter element 21 by the tilt surface of the protrusion of the diffuse plate 206, an angle of the tilt surface of the protrusion is changed in accordance with the distance from the polarization converter element 21. When an angle of the tilt surface of the protrusion far from the polarization converter element 21 or far from the LED is set to “a” while an angle of the tilt surface of the protrusion close to the polarization converter element 21 or close to the LED is set to “α′”, α is smaller than α′ (α<α′). By such setting, the luminous flux having been converted in terms of the light polarization can be effectively used.

<Lenticular Lens>

A method of adjusting the diffuse distribution of the image light emitted from the liquid crystal display panel 11 is exemplified as arrangement of a lenticular lens between the light source apparatus 13 and the liquid crystal display panel 11 or on the surface of the liquid crystal display panel 11 and optimization of a shape of this lens. In other words, by the optimization of the shape of the lenticular lens, the light emission property of the image light (also referred to as “image luminous flux” below) emitted in one direction from the liquid crystal display panel 11 can be adjusted.

A micro lens array in a matrix form may be alternatively or additionally arranged on the surface of the liquid crystal display panel 11 (or between the light source apparatus 13 and the liquid crystal display panel 11) to adjust an aspect of the arrangement. In other words, by the adjustment of the arrangement of the micro lens array, the light emission property of the image luminous flux emitted from the image display apparatus 1 in the X-axis direction and the Y-axis direction can be adjusted, and, as a result, an image display apparatus having the desirable diffuse property can be provided.

A function of the lenticular lens will be explained. When the lenticular lens having the optimized lens shape as described above is used, the following functional effect can be provided. In other words, the light emission property of the image luminous flux emitted from the image display apparatus 1 is adjusted (optimized) through the lenticular lens, and the optimized image luminous flux is efficiently transmitted or reflected by the window glass 105, and therefore, the favorable aerial floating image can be provided.

As another configuration example, combination of two lenticular lenses may be arranged or a sheet in which the micro lens array in the matrix form is arranged for adjusting the diffuse property may be arranged at a position at which the image light emitted from the image display apparatus 1 passes. By such an optical system configuration, a luminance (relative luminance) of the image light in the X-axis direction and the Y-axis direction can be adjusted in accordance with the reflection angle of the image light (the reflection angle provided when the reflection in the vertical direction is set to a criterion (0 degree)).

Because of use of such a lenticular lens, the present example can provide the excellent optical property as shown with the graph (plot curve) of “the first example (Y-axis direction)” and “the second example (Y-axis direction)” in FIG. 22(B) that is clearly different from the graph (plot curve) of the related-art property. Specifically, in the graph (plot curve) of “the first example (Y-axis direction)” and “the second example (Y-axis direction)”, since the luminance property in the vertical direction is made sharp, and the balance of the directionality of the up and down directions (the positive and negative directions in the Y-axis direction) is changed, and, as a result, the luminance (relative luminance) of the light due to the reflection and the diffusion can be increased.

Therefore, the present example can provide the image light having the narrow diffuse angle (high straightness) and only the specific polarized wave component as similar to the image light emitted from the surface light emitting laser image source, can suppress the ghost image generated in the retroreflector in the case of the use of the image display apparatus of the related art, and can adjust the light so that the aerial floating image generated by the retroreflection efficiently reaches the eyes of the viewing person.

By the light source apparatus, the diffuse property (referred to as “related-art property” in the drawings) of the light emitted from the general liquid crystal display panel as shown in FIGS. 22 (a) and (b) can be provided with the directionality having the significantly narrow angle in both the X-axis direction and the Y-axis direction. Since the present example can provide such directionality having the narrow angle, the image display apparatus emitting the nearly collimated image luminous flux in the specific direction and emitting the light with the specific polarized wave can be achieved.

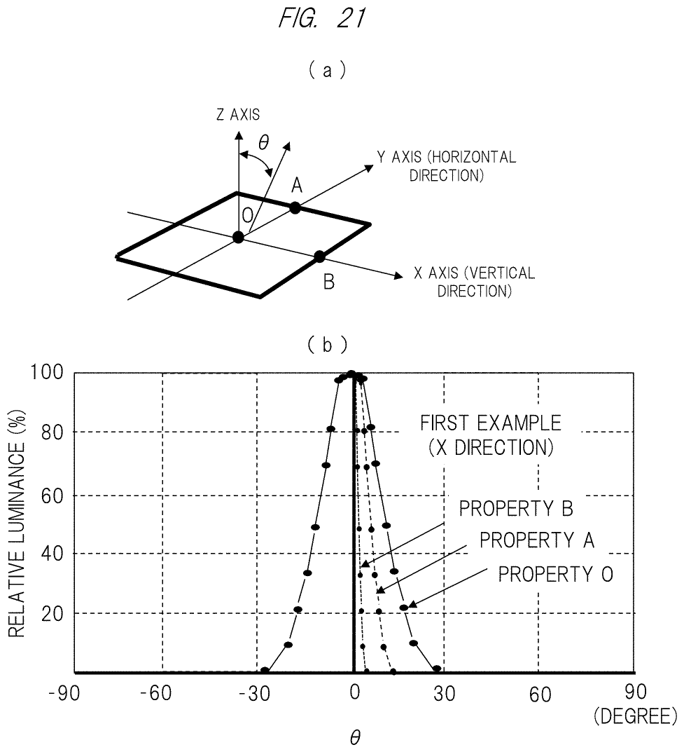

FIG. 21 shows one example of the property of the lenticular lens applied to the present example. In this example, the property in the X-axis direction (vertical direction) with respect to the Z-axis direction is particularly exemplified, and a property “0” indicates a luminance property having a peak of the light emission direction at an angle that shifts upward by nearly 30 degrees from the vertical direction (0 degree) and being symmetric in the up-and-down direction. Plot curves of a property “A” and a property “B” shown in the graph of FIG. 21 indicate property examples in which the luminance (relative luminance) is increased by collection of the upper image light of the peak luminance at nearly 30 degrees. Therefore, in these properties A and B, as seen from the comparison with the plot curve of the property O, the luminance (relative luminance) of the light is rapidly decreased in a region of an angle (θ>30°) where the tilt (angle θ) from the Z-axis direction toward the X direction exceeds 30 degrees.

In other words, according to the optical system including the lenticular lens, when the image luminous flux emitted from the image display apparatus 1 is caused to enter the retroreflector 2, the light emission angle and the viewing angle of the image light having the equalized narrow angle by the light source apparatus 13 can be adjusted, and the degree of freedom of the layout of the retroreflection sheet 2 can be significantly improved. As a result, the degree of freedom regarding the image forming position of the aerial floating image formed at the desirable position after being reflected by or transmitted through the window glass 105 can be significantly improved. As a result, the light serving as the light having the narrow diffuse angle (high straightness) and having only the specific polarized wave component can efficiently reach the eyes of the viewing person outside or inside the room. Therefore, even if the intensity (luminance) of the image light emitted from the image display apparatus 1 is decreased, the viewing person can correctly recognize the image light and obtain the information. In other words, the information display system having the low power consumption because of the small output of the image display apparatus 1 can be achieved.

In the foregoing, various embodiments and examples (that are the specific examples) to which the present invention is applied has been concretely described. On the other hand, the present invention is not limited to the foregoing embodiments (specific examples), and includes various modification examples. For example, in the above-described embodiments, the entire system has been explained in detail for easily understanding the present invention, and the above-described embodiments are not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

The light source apparatus explained above is not limited to the aerial floating image display apparatus, and is also applicable to the information display apparatuses such as an HUD, a tablet and a digital signage.

In the technique according to the present embodiment, the aerial floating image is displayed in a state where the high-resolution and high-luminance image information is floated in air, and, as a result, for example, the user can perform operations without concern about contact infection in illness from infection. When the technique according to the present embodiment is applied to the system that is used by many and unspecified users, a non-contact user interface having the decrease in the risk of the contact infection in the illness for infection, and thus, being usable without the concern can be provided. The present invention providing such a technique contributes to “the third goal: Good Health and Well-being (for all people)” of the sustainable development goals (SDGs) advocated by the United Nations.

Since only the specular reflection light is efficiently reflected with respect to the retroreflector by the technique according to the present embodiment of making the divergence angle of the emitted image light small and equalizing the specific polarized wave, the light use efficiency is high, and the bright and clear aerial floating image can be provided. The technique according to the present embodiment can provide a non-contact user interface being excellent in availability and capable of significantly reducing the power consumption. The present invention providing such a technique contributes to “the ninth goal: Industry, Innovation and Infrastructure” and “the eleventh goal: Sustainable Cities and Communities” of the sustainable development goals (SDGs) advocated by the United Nations.

Further, the technique according to the present embodiment can form the aerial floating image based on the image light having the high directionality (straightness). In the technique according to the present embodiment, even in a case of display of an image that needs the high security in an ATM of a bank, a ticketing machine of a station and others or an image having a high secret level that needs to be secret to a person who faces the user, a non-contact user interface having a less risk of other person's looking at the aerial floating image than the user can be provided by the display of the image light having the high directionality. The present invention provides the technique as described above, and contributes to “the eleventh goal: Sustainable Cities and Communities” of the sustainable development goals (SDGs) advocated by the United Nations.

### EXPLANATION OF REFERENCE CHARACTERS

1 . . . image display apparatus, 2 . . . retroreflector, 3 . . . spatial image (aerial floating image), 105 . . . window glass, 100 . . . light transmittable plate, 101 . . . polarization splitter, 12 . . . absorption-type light polarizer, 13 . . . light source apparatus, 54 . . . light-direction converting panel, 151 . . . retroreflector, 102 and 202 . . . LED board, 203 . . . light guiding body, 205 . . . reflection sheet, 271 . . . reflection plate, 206 and 270 . . . waveplate, 300 . . . aerial floating image, 301 . . . ghost image of aerial floating image, 302 . . . ghost image of aerial floating image, 11 . . . liquid crystal display panel, 206 . . . diffuse plate, 21 . . . polarization converter element, 300 . . . LED reflector, 213 . . . λ/2 plate, 306 . . . reflection-type light guiding body, 307 . . . reflection surface, 308 and 310 . . . sub reflector, 81 . . . optical element, 501 . . . polarization converter element, 503 . . . unit, 507 . . . light shielding wall, 401 and 402 . . . light shielding plate, 320 . . . base member

1. An aerial floating image display apparatus comprising:
a display panel displaying an image;
a light source apparatus; and
a retroreflector capable of reflecting image light having been emitted from the display panel and causing the reflected light to display an aerial floating image that is an actual image in air,
wherein the light source apparatus includes:
a light source of a point type or a surface type;
a reflector reflecting light having been emitted from the light source; and
a light guiding body guiding light having been emitted from the reflector toward the display panel, and
a reflection surface of the reflector has a shape that is asymmetric across an optical axis of the light having been emitted from the light source.

2. The aerial floating image display apparatus according to claim 1,
wherein the light guiding body is a reflection-type light guiding body guiding light by causing a reflection surface on a surface of the light guiding body to reflect the light.

3. The aerial floating image display apparatus according to claim 1 further comprising:
a diffuse plate diffusing light having been emitted from the light guiding body; and
a sidewall arranged to sandwich a gap between the light guiding body and the diffuse plate.

4. The aerial floating image display apparatus according to claim 1,
wherein a plastic material, a glass material or a metallic material is used for the reflector.

5. The aerial floating image display apparatus according to claim 1,
wherein the light source apparatus includes:
a second reflector reflecting a part of light having been reflected by the reflector; and
a third reflector reflecting light having been reflected by the second reflector, toward the light guiding body.

6. The aerial floating image display apparatus according to claim 5,
wherein the third reflector is arranged to extend in one direction, and
an apex of the third reflector has a convex and concave shape including one or more concave portions that are periodically arranged in the one direction.

7. The aerial floating image display apparatus according to claim 6,
wherein the light source includes a plurality of light emission units, and
each of the plurality of light emission units is periodically arranged in the one direction to correspond to an arrangement pitch of the concave portion of the convex and concave shape of the third reflector.

8. The aerial floating image display apparatus according to claim 7,
wherein a height of the concave portion of the convex and concave shape of the apex of the third reflector is lower than a height of the light emission unit of the light source.

9. The aerial floating image display apparatus according to claim 7,
wherein a reflection surface included in a convex portion of the convex and concave shape of the apex of the third reflector reflects and guides the light having been reflected by the second reflector, toward the light guiding body.

10. The aerial floating image display apparatus according to claim 1,
wherein the light guiding body is a transmission-type light guiding body guiding light by transmitting the light through the light guiding body.

11. The aerial floating image display apparatus according to claim 10,
wherein the transmission-type light guiding body has:
a refraction surface that is a surface facing the display panel and adjusting an emission direction of light emitted from the light guiding body toward the display panel; and
a reflection surface reflecting light having been emitted from the reflector, toward the refraction surface.

12. The aerial floating image display apparatus according to claim 11,
wherein a shape of the refraction surface of the transmission-type light guiding body is a shape having a plurality of surfaces that are different from one another in tilt.

13. The aerial floating image display apparatus according to claim 11,
wherein a shape of the reflection surface of the transmission-type light guiding body is a shape having a plurality of surfaces that are different from one another in tilt.

14. An aerial floating image display apparatus comprising:
a display panel displaying an image;
a light source apparatus; and
a retroreflector capable of reflecting image light having been emitted from the display panel and causing the reflected light to display an aerial floating image that is an actual image in air,
wherein the light source apparatus includes:
a light source of a point type or a surface type;
a light guiding body guiding light having been emitted from the light source, toward the display panel;
a diffuse plate diffusing light having been emitted from the light guiding body; and
a sidewall arranged to sandwich a gap between the light guiding body and the diffuse plate.

15. The aerial floating image display apparatus according to claim 14,
wherein the light source apparatus includes:
a polarization converter equalizing light having been emitted from the light source, to be polarized light having specific directionality, and
a light emission surface of the polarization converter faces a space surrounded by the sidewall, the light guiding body, the diffuse plate, and the polarization converter.

16. The aerial floating image display apparatus according to claim 15,
wherein a surface of the sidewall, the surface facing the space, includes a reflection region having a reflection film,
the sidewall has a surface covering the polarization converter from a side surface, and
the surface covering the polarization converter from the side surface is a surface having a lower reflectance of light than a reflectance of the reflection region.

17. The aerial floating image display apparatus according to claim 14,
wherein, in the sidewall, a part of the sidewall includes a ventilation hole.

18. An aerial floating image display apparatus forming an aerial floating image, comprising:
a liquid crystal panel serving as an image display apparatus; and
a light source apparatus supplying light having specific polarization directionality to the liquid crystal panel,
wherein the light source apparatus includes:
a light source of a point type or a surface type;
an optical member decreasing a divergence angle of the light having been emitted from the light source;
a polarization converter equalizing light having been emitted from the light source, to be polarized light having specific directionality; and
a light guiding body having a reflection surface propagating light to the liquid crystal panel,
the light guiding body is arranged to face the liquid crystal panel, and has a reflection surface inside or on a surface of the light guiding body, the reflection surface reflecting the light having been emitted from the light source toward the liquid crystal panel, and transmits the light to the image display apparatus,
the liquid crystal panel modulates light intensity in accordance with an image signal,
the light source apparatus adjusts a part or entire of a divergence angle of luminous flux entering the liquid crystal panel from the light source by using a shape or surface roughness of a reflection surface formed in the light source apparatus, and
image luminous flux having a narrow divergence angle having been emitted from the liquid crystal panel is reflected by a retroreflector, and forms the aerial floating image in air.

19. The aerial floating image display apparatus according to claim 18,
wherein the light source apparatus adjusts a part or entire of the divergence angle of the luminous flux by using the shape or the surface roughness of the reflection surface of the light source apparatus so that the light divergence angle of the liquid crystal panel configuring the image display apparatus is within ±30 degrees.

20. The aerial floating image display apparatus according to claim 18,
wherein the light source apparatus adjusts a part or entire of the divergence angle of the luminous flux by using the shape or the surface roughness of the reflection surface of the light source apparatus so that the light divergence angle of the liquid crystal panel configuring the image display apparatus is within ±10 degrees.

21. The aerial floating image display apparatus according to claim 18,
wherein the light source apparatus adjusts a part or entire of the divergence angle of the luminous flux by using the shape or the surface roughness of the reflection surface of the light source apparatus so that a horizontal divergence angle and a vertical divergence angle of the light divergence angle of the liquid crystal panel configuring the image display apparatus are different from each other.

22. The aerial floating image display apparatus according to claim 18,
wherein the light source apparatus has a contrast performance resulted from multiplication of an inverse number of an efficiency of light-polarization conversion in the polarization converter with a contrast resulted from a property of a light polarizer arranged on a light entering surface and a light emission surface of the liquid crystal panel.

23. The aerial floating image display apparatus according to claim 18,
wherein image light having been emitted from the liquid crystal panel is arranged to be temporarily reflected by a reflection-type light polarizer, and then, to enter the retroreflector,
an image-light entering surface of the retroreflector is provided with a waveplate, and
the image light is transmitted through the reflection-type light polarizer by being transmitted through the waveplate twice to convert a polarized wave of the image light to a different polarized wave.

24. The aerial floating image display apparatus according to claim 23,
wherein the light source apparatus has a contrast performance resulted from multiplication of an inverse number of a cross transmittance of the reflection-type light polarizer and an inverse number of an efficiency of light-polarization conversion in the polarization converter with a contrast resulted from a property of a light polarizer arranged on a light entering surface and a light emission surface of the liquid crystal panel.

25. The aerial floating image display apparatus according to claim 18,
wherein the light guiding body guides light to the liquid crystal panel by causing light having specific polarization directionality having been reflected by a reflection-type light polarizer to be transmitted through a surface connecting the adjacent reflection surfaces of the light guiding body, causing the light to be reflected by a reflation plate arranged on a surface of the light guiding body opposite to a surface being in contact with the liquid crystal panel, causing the light to be converted in terms of light polarization by being transmitted through a waveplate arranged on an upper surface of the reflection plate twice to be a polarized wave transmitted through the reflection-type light polarizer, and causing the light to be transmitted through the light guiding body.

26. An aerial floating image display apparatus forming an aerial floating image, comprising:
a liquid crystal panel serving as an image display apparatus; and
a light source apparatus supplying light having specific polarization directionality to the liquid crystal panel,
wherein the light source apparatus includes:
a light source of a point type or a surface type;
an optical member decreasing a divergence angle of the light having been emitted from the light source;
a light guiding body having a reflection surface reflecting the light having been emitted from the light source and propagating the light to the liquid crystal panel; and
a waveplate and a reflection surface sequentially arranged from the light guiding body to face a different surface of the light guiding body,
the reflection surface of the light guiding body is arranged to reflect the light having been emitted from the light source and to propagate the light to the liquid crystal panel facing the light guiding body,
a reflection-type light polarizer is arranged between the reflection surface of the light guiding body and the liquid crystal panel,
light having specific polarization directionality having been reflected by the reflection-type light polarizer is polarized by causing the light to be reflected by a reflection surface being tightly close to and facing a different surface of the light guiding body, and being transmitted through the waveplate arranged between the light guiding body and the reflection surface twice, the light is transmitted through the reflection-type light polarizer, and the light having specific polarization directionality is propagated toward the liquid crystal panel,
the liquid crystal panel modulates light intensity in accordance with an image signal,
the light source apparatus adjusts a part or entire of a divergence angle of luminous flux entering the liquid crystal panel from the light source by using a shape or surface roughness of a reflection surface formed in the light source apparatus, and
image luminous flux having a narrow divergence angle having been emitted from the liquid crystal panel is reflected by a retroreflector, and forms the aerial floating image in air.

27. The aerial floating image display apparatus according to claim 25,
wherein the light source apparatus adjusts a part or entire of the divergence angle of the luminous flux by using the shape or the surface roughness of the reflection surface of the light source apparatus so that the light divergence angle of the liquid crystal panel configuring the image display apparatus is within ±30 degrees.

28. The aerial floating image display apparatus according to claim 25,
wherein the light source apparatus adjusts a part or entire of the divergence angle of the luminous flux by using the shape or the surface roughness of the reflection surface of the light source apparatus so that the light divergence angle of the liquid crystal panel configuring the image display apparatus is within ±10 degrees.

29. The aerial floating image display apparatus according to claim 25,
wherein the light source apparatus adjusts a part or entire of the divergence angle of the luminous flux by using the shape or the surface roughness of the reflection surface of the light source apparatus so that a horizontal divergence angle and a vertical divergence angle of the light divergence angle of the liquid crystal panel configuring the image display apparatus are different from each other.

30. The aerial floating image display apparatus according to claim 25,
wherein the light source apparatus has a contrast performance resulted from multiplication of an inverse number of a cross transmittance of the reflection-type light polarizer with a contrast resulted from a property of a light polarizer arranged on a light entering surface and a light emission surface of the liquid crystal panel.

31. The aerial floating image display apparatus according to claim 25,
wherein image light having been emitted from the liquid crystal panel is arranged to be temporarily reflected by a reflection-type light polarizer, and then, to enter the retroreflector,
an image-light entering surface of the retroreflector is provided with a waveplate, and
the image light is transmitted through the reflection-type light polarizer by being transmitted through the waveplate twice to convert a polarized wave of the image light to a different polarized wave.

32. The aerial floating image display apparatus according to claim 31,
wherein the light source apparatus has a contrast performance resulted from multiplication of an inverse number of a cross transmittance of each of the two reflection-type light polarizers with a contrast resulted from a property of a light polarizer arranged on a light entering surface and a light emission surface of the liquid crystal panel.

33. The aerial floating image display apparatus according to claim 18 further comprising:
an image control input unit having a TOF (Time of Fly) function to sense a distance between a sensor and an object in the displayed aerial floating image and a position of the object; and
an image display apparatus.

34. The aerial floating image display apparatus according to claim 18,
wherein the light source apparatus includes a plurality of the light sources to correspond to one image display element.

35. The aerial floating image display apparatus according to claim 18,
wherein the light source apparatus includes a plurality of light sources of surface type having different light emission directionality to correspond one image display element.

36. The aerial floating image display apparatus according to claim 33,
wherein the divergence angle is within ±30 degrees.

37. The aerial floating image display apparatus according to claim 36,
wherein the divergence angle is within ±10 degrees.

38. The aerial floating image display apparatus according to claim 36,
wherein a horizontal divergence angle and a vertical divergence angle are different from each other.

39. The aerial floating image display apparatus according to claim 18,
wherein an optical member having a lens function is arranged either between the liquid crystal panel and the retroreflector or between the retroreflector and the aerial floating image, or both between the liquid crystal panel and the retroreflector and between the retroreflector and the aerial floating image.

40. The aerial floating image display apparatus according to claim 39,
wherein a size of the aerial floating image and an image forming position of the aerial floating image resulted from eccentric or tilt arrangement of the optical member from an optical axis connecting the image display apparatus and the retroreflector are optionally set with respect to the optical axis.

41. The aerial floating image display apparatus according to claim 39,
wherein the light source apparatus adjusts a part or entire of the divergence angle of the luminous flux by using the shape or the surface roughness of the reflection surface of the light source apparatus so that the light divergence angle of the liquid crystal panel configuring the image display apparatus is within ±30 degrees.

42. The aerial floating image display apparatus according to claim 39,
wherein the light source apparatus adjusts a part or entire of the divergence angle of the luminous flux by using the shape or the surface roughness of the reflection surface of the light source apparatus so that the light divergence angle of the liquid crystal panel configuring the image display apparatus is within ±10 degrees.

43. The aerial floating image display apparatus according to claim 39,
wherein the light source apparatus adjusts a part or entire of the divergence angle of the luminous flux by using the shape or the surface roughness of the reflection surface of the light source apparatus so that a horizontal divergence angle and a vertical divergence angle of the light divergence angle of the liquid crystal panel configuring the image display apparatus are different from each other.
